(19) United States
(12) Patent Application Publication
(10) Pub. No.: US 2007/0162844 A1
(43) Pub. Date: Jul. 12, 2007

(54) Automatic layout of objects

(75) Inventors: Zachary Woodall, Issaquah, WA (US); Stephen Lesser, Redmond, WA (US); Pavel Karimov, Redmond, WA (US); Tosh Kawai, Kirkland, WA (US); Kumar Srinivasamurthy, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/331,387

(22) Filed: Jan. 12, 2006

(51) Int. Cl. G06F 17/00

(52) U.S. Cl. 715/517

(57) ABSTRACT

In some implementations, selected objects are arranged within a view. Each object is assigned an ordinal value, regardless of data type, according to the object's position in a first direction (e.g., horizontal position) relative to other objects of the layout grouping. The objects are linearly aligned along a line parallel to the first direction (e.g., horizontally). Each object's position is then minimally adjusted in the first direction (e.g., horizontally) such that the object has a minimum distance from each other object having a lower ordinal value without overlapping any of the other objects. In some other implementations, a computer-readable medium contains computer-readable instructions that, when executed by a computer system, cause the computer system to perform the above-described method. In still other implementations, a computer system has a memory containing computer-readable instructions that, when executed by the computer system's processor, cause the processor to perform the method.

### BACKGROUND

Database designers have traditionally used Microsoft Access and other database applications to create databases and to create tools that allow users, who need not be familiar with databases, to manipulate data within the databases. For example, a designer may create a form containing a textbox into which a user can type a query and a button that initiates a search throughout the database for records that match the query. In response to the search, a tool may generate a report or other form containing records that match the query. The textbox and the button may be known as “controls,” since they give a user some control over how the search is to be performed. Other types of controls have commonly allowed the user to change the way the search is performed or the way the report presents the records that are found in the search. Each field in the report may also be considered a control. Within a form, a user may be allowed to perform a search in different ways. Within a report, controls may be included that allow a user to re-execute the query, sort the records found in a different order, save the report, or email the report. These controls may be command buttons, radio buttons, or other controls.

Designers have traditionally designed views (such as forms and reports) with particular users in mind. The designer may design a view's user interface (UI) so that the user can almost intuitively understand the functionality of each control. Deciding where in a form or in a report to place each control can be difficult and time-consuming for the designer. Furthermore, there are few tools to help the designer lay out the forms and controls for a database application. If a form contains many controls and other objects that undesirably overlap one another as the designer adds them to a form or report in “design mode,” the designer may wish to move the controls so that when the user opens the form or report in “browse mode” the objects do not overlap.

Some UI elements or objects such as labels can present another difficulty for the designer. A label such as a text label or a graphic may be regarded as an object that helps the user understand what the function of a related control. The designer may therefore want each label to be positioned near the control whose use it describes. A label “phone number” may be best positioned near a textbox control in which the user may type a phone number, for example. If a view contains a large number of controls, and if many of the controls have labels associated therewith, then the designer may have a tedious task moving all of the objects into non-overlapping positions. Building forms and reports can be very time consuming and difficult, and UI elements such as objects can be difficult to position within each view.

### BRIEF DESCRIPTION OF THE DRAWINGS

Although the disclosure herein refers to certain illustrated embodiments, it is to be understood that these embodiments are presented by way of example and not by way of limitation. Not all modifications, alternatives, and equivalents of the embodiments are described, and other embodiments may fall within the spirit and scope of the invention. It is to be understood and appreciated that the process steps and structures described herein do not cover a complete process flow nor all elements and components that may be found in a complete product, apparatus, or system. The following description is therefore presented for illustrative purposes.

FIG. 1 shows a selection widget that may be used to select a layout grouping.

FIG. 2 is a diagram of a view to which a plurality of objects, including objects set forth in a Field Chooser, may be added.

FIG. 3 is a diagram of screens in which a plurality of objects has been added to the view of FIG. 2.

FIG. 4 is a diagram of a screen, showing a selection of controls from which to create layout grouping.

FIG. 5 is a diagram of a screen depicting a creation of a layout grouping.

FIG. 6 is a diagram of a screen depicting components of a layout grouping.

FIG. 7 is a diagram of a screen showing a selection of a control in a row of a table having a tabular table format.

FIG. 8 is a diagram of a screen.

FIG. 9 is a diagram of a screen showing a selection of a row.

FIG. 10 is a diagram of a screen showing a selection of a table.

FIG. 11 is a diagram of a screen showing a selection of a group of user-interface objects within a view.

FIG. 12 is a schematic diagram of a screen-shot showing a selection of a column, (that is, of a control group) of a table having a stacked table format.

FIG. 13 is a screen showing a resizing of columns in a table having a stacked tabular layout.

FIG. 14 is a diagram of a screen of a Ribbon Command user-interface.

FIG. 15 shows several Gridlines Gallery Options.

FIG. 16 is a screen of a Context Menu command user-interface.

FIG. 17 is a diagram of a screen depicting an application of gridlines to a typical data set.

FIG. 18 is a partial screen layout depicting Margins and Padding.

FIG. 19 is a diagram of a screen showing a Margins Gallery.

FIG. 20 is a diagram of a screen in which an object is added to a table that has a tabular table format.

FIG. 21 is a diagram of a screen depicting a modified object being added to a view.

FIG. 22 is a diagram of a screen showing an ungrouping of a control.

FIG. 23 is a flowchart depicting a method.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Inclusion of certain aspects and implementations in the description below should not be regarded as excluding other aspects and implementations. For example, in accordance with some aspects and implementations that are herein described, selected non-label objects may collectively be regarded as a layout grouping and may be arranged within a view. Each may be assigned an ordinal value, regardless of data type, according to each object's position in a first direction (e.g., horizontal position) relative to other objects of the layout grouping. The objects may be linearly aligned along a line parallel to the first direction (e.g., horizontally). Each object's position may then be minimally adjusted in the first direction (e.g., horizontally) such that the object has a minimum distance from each other object having a lower ordinal value, without overlapping any of the other objects. Such aspects and implementations should not be regarded as limiting, since other aspects and implementations are also contemplated. For example, in accordance with another aspect and implementation, a computer-readable medium contains computer-readable instructions that, when executed by a computer system, cause the computer system to perform the above-described method. In accordance with still another aspect and implementation, a computer system has a memory containing computer-readable instructions that, when executed by the computer system's processor, cause the processor to perform the method.

Moreover, description of various embodiments in terms of software programs running on a computer processor, for example, should not be interpreted as excluding other embodiments having dedicated hardware implementations including, but not limited to application specific integrated circuits (ASICs) and programmable logic arrays (PLAs). Other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

### DETAILED DESCRIPTION

Reference will now be made in detail to various embodiments of the invention, examples of which are illustrated in the accompanying drawings. Wherever possible, the same or similar reference numbers are used in the drawings and the description to refer to the same or like parts. It should be noted that the drawings are in simplified form and are not to precise scale. In reference to the disclosure herein, for purposes of convenience and clarity only, directional terms, such as, top, bottom, left, right, up, down, over, above, below, beneath, rear, and front, are used with respect to the accompanying drawings. Such directional terms should not be construed to limit the scope of the invention in any manner.

In a first embodiment, a tool allows a designer to select several objects and coerce the selected objects into a layout grouping. The objects may be coerced into rows and columns that allow space between adjacent objects. The selected objects may be moved en masse to a region of the view that does not overlap anything else within the view, so a designer may reduce clutter within a view, and then the designer may move each object individually. Labels are also accommodated, and a label may be automatically positioned or moved whenever an object to which the label corresponds may be positioned or moved. Row groupings, columnar groupings, section groupings, region groupings, and entire layout groupings may be manipulated as groups, which can greatly facilitate laying out a view in design mode because objects that may have been hidden by other objects can become visible to the user and manipulated collectively. Since the objects need not belong to a formal table structure, such groupings may be temporary and short-lived, existing only for an immediate purpose of manipulating and/or arranging placement of the objects within a view. Any underlying table structure may be preserved and/or restored after the objects are manipulated or arranged. Although the manipulating and/or arranging of the placement of the objects may be undone using a user-friendly “undo” feature, no association among the objects thus manipulated or arranged need be preserved.

Once an object such as a control is positioned, it can become data-bound to a data field. For example, if the database contains data about individuals, then the data field may be regarded as a category of information that may be shared by most or all the individuals. For example, Family Name, Employee Number, Phone Number, and other categories of information relating to a person may be regarded as data fields. Each category of information may be data-bound to an object. In a form, a user may enter a search parameter into an object such as a control. In a report that displays results of a database search, an object may contain data pertaining to one of the individuals obtained from the database. All of the data pertaining to an individual may be described as a record. Therefore, each record contains data from each of the fields, and each field contains data of one category pertaining to many individuals. The designer data-binds the database to the views by connecting particular fields of the database with particular objects of the views.

In other words, in browse mode within a form, an object that is data-bound to a field can be used to search the field in all records of the database. Records that are “hit” in a database search can be provided to a “hit list” to allow the user to select a record, or each record returned by the database search can be selected one record at a time. Each selected record can be provided to a report, in which each object presents a field of the selected record.

A “view” may be regarded as a presentation of information that may or may not contain one or more layouts. A view may be entirely comprised of layouts, may contain a mix of layouts and non-managed objects, or may contain only unmanaged objects. Any number of layouts can exist in a view. Each layout may be regarded as a collection of objects whose size and position are being managed as a group by Microsoft Access or other software without the use of a formal table structure. Each view may be, for example, a tabular layout, a stacked layout, or other type of layout, or combination thereof. A tabular layout may be regarded as a collection of columnar groupings, and a stacked layout may be regarded as a collection of row-wise groupings. Each columnar grouping of the tabular layout may be a layout grouping of objects, which may be regarded as belonging to the columnar grouping regardless of data type. The terms “object” and “control” are hereinafter used interchangeably, and may be understood as substantially synonymous. Similarly, each row-wise grouping of the stacked layout may be a layout grouping of objects. A columnar grouping and/or a row-wise grouping may include any type of Microsoft Access object, for example. A tabular layout may resemble a spreadsheet, in that labels may be placed along a top row to identify columns, and objects may be placed in rows below corresponding columns. A stacked layout may resemble a form, with labels along a left column or right column, and each object situated horizontally from a corresponding label.

A designer who has created a form or a report as part of a Microsoft Access application or other similar application may have placed a large number of objects on the form or report. A cluttered region with the form or report may have a large number of objects, some of which have labels corresponding thereto. Due to the clutter, the designer may be overwhelmed, and may be frustrated trying to separate each object and position it appropriately. To solve the problem, the designer may decide to move a group of the objects away from the cluttered region to an unused region within the view. Once the layout grouping has been moved to the unused region, the designer may then wish to rearrange the objects in the group such that no object overlaps any other object within the group. Throughout the moving and the separating, however, the designer may wish that any objects that are labels remain near the objects to which they correspond. Finally, the designer may move each object back into the previously-cluttered region, one object at a time, so that it may be positioned where desired. Of course, it should be understood that the foregoing is merely an example, and is not limited to cluttered regions or where objects overlap.

The designer may select a layout grouping such that the layout grouping does not include any labels. Although labels are objects, the designer may decide to select a layout grouping that does not include any labels. Alternatively, the designer may select a layout grouping and then may generate a command that causes any labels to be deselected, such that the layout grouping does not include any labels. A preference in a Preferences Table may allow the designer to “turn on” automatic de-selection of labels.

Row groupings, columnar groupings, section groupings, and table groupings may be considered “layout groupings” for purposes of this description. Layout groupings may contain other layout groupings, such as traditional row, column, section, and table groupings. For example, if a table contains a “header section” that includes one or more rows (including the first row of the table) and a “detail section” that includes one or more rows (e.g., rows that contain database data), then each section may be considered a distinct layout grouping. A particular object may reside within a row, a column, a section, and a table. The rows and columns may include objects, and each object may belong to a row, a column, and a table. The layout grouping herein described need not be a row, column, or table; in fact, the layout grouping may be discontiguous, in that the designer may select objects from different rows, columns, sections, and tables. The objects may be of different data types, have different properties, and be located in different locations throughout the view. If desired, the objects may reside in a different page, tab pages, subdocuments, documents, or files.

Each object of the layout grouping has a position within the view. If desired, the position of each object of the layout grouping may be provided as an absolute position. For example, the position of each object may be described as a distance from a left edge and a top edge of the view itself. Absolute position of each object may facilitate compatibility with other software applications or with other versions of Microsoft Access. Alternatively, the position of each object of the layout grouping may be provided as a relative position, wherein the layout grouping as a whole has an absolute position, but each object within the layout grouping has a relative position with respect to the absolute position of the layout grouping. For example, the position of each object may be described as a distance from another object, or a distance from a first object in the layout grouping, rather than from edges of the view itself. A designer may command that the positions of an object, layout grouping, or other layout grouping be converted from relative positions to absolute positions, or from absolute positions to relative positions.

The view (or a layout within the view) may have properties unto itself. For example, the view may have gridlines and spacing between tables, rows, columns, sections, and cells. Such properties may be implemented as a property of each table, row, column, cell, or object, or may be stored as a property of the layout itself.

Accordingly, a discontinuous placement of objects may be managed relative to each other. For example, objects in different sections may conform to different rules. A modification to the size or position of an object may affect other objects related to it by the layout, but each object in a different way depending on the way it is related. For example, resizing the width of a control displaying data in a tabular layout may automatically resize the width of a label of that control to match as well. In this way contiguity may be enforced. However, in the same situation, the label need not be affected by a change in the height placement of the data bound control. The data bound control may have freedom to move up and down regardless of the placement of its label. This action does not break the continuity of the layout, and so it is permitted. The same rule may not apply to traditional Table concepts or the Excel datasheet. Selecting The Layout Grouping

The designer may select the layout grouping in any of a variety of ways. For example, the designer may use a graphical designer interface, or GUI, to select each object of the layout grouping individually. The designer may use a mouse and a cursor to draw a “box” (called a “selection widget”) around objects to select the objects.

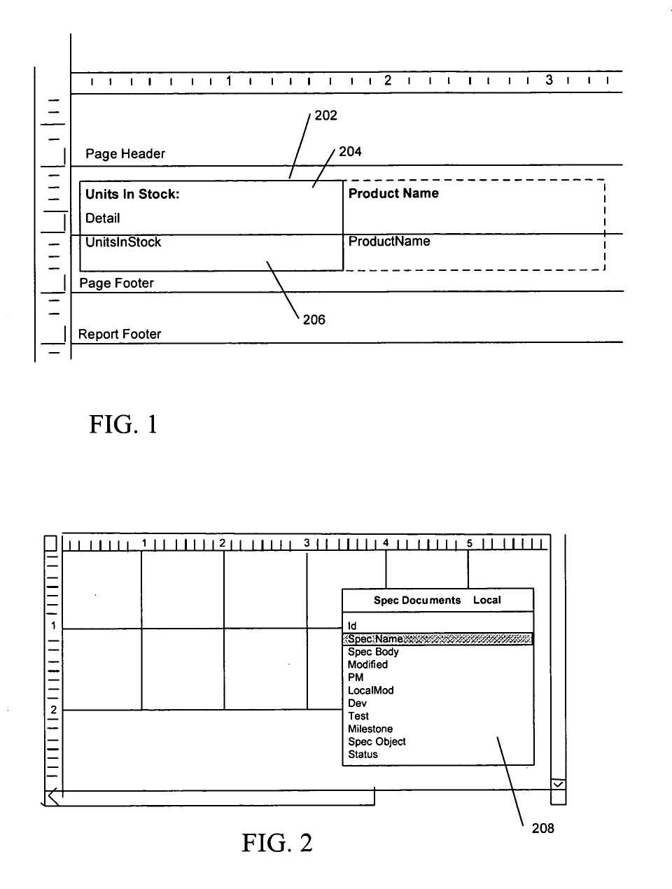

FIG. 1 shows a selection widget 202 that may be used to select a layout grouping. The selection widget 202 has been used to enclose an object, i.e. a Units in Stock textbox 204, which has a Units in Stock label 206 corresponding thereto. If desired, the selection widget 202 may be implemented to show that the Units in Stock label 206 may be included as selected.

Selecting more than one object may also be accomplished, for example, by holding down a “Shift” key or an “Object” key and selecting additional objects for the layout grouping. Selecting an additional object for the layout grouping may be regarded as “multi-selecting.” The designer may also multi-select objects by drawing a box around the objects, with or without the Shift key or Object key held down.

Other software modules operative to select a layout grouping are also contemplated and may be used to select objects, and thereby identify and define a layout grouping that may be of interest. For example, the designer may use a software module to select all objects that share a common property within a particular cell, row, column, section, or layout. The designer may search the cell, row, column, section, or layout to find and select objects that share a desired property, such as all objects that have bold formatting, all non-graphic objects, or all printable objects. The designer may also use a date-search to find and select all objects that have been created in the most recent 24-hour period within the particular cell, row, column, section, or layout. The designer may use a text-content search to identify all objects that contain text, or that contain specified text. The designer may also choose to use a Ribbon Command (i.e., a button to allow the user-interface to be presented as a command bar along an edge of the view). Other techniques for selecting a layout grouping are also contemplated.

Similarly, the designer may multi-select an entire row, an entire column, an entire table, or an entire view, by clicking on a special module for this purpose. When a designer clicks at an end of a row or column, the entire row or column may be selected. When a designer clicks at a comer of a table, the entire table may be selected, and when a designer clicks at a comer of the layout, the entire layout may be selected. Any group, including layout groupings such as rows, columns, sections, and tables may be multi-selected. Selecting a group such as a layout grouping has an effect of selecting all objects therein. As indicated above, however, any objects that are labels may be automatically de-selected.

### Adding New Objects to the Layout Grouping

New objects may be added to a layout grouping. The new objects may already reside within the view, or may be added directly, for example, from a list of fields of the database. If the new objects reside within the view, the designer may simply select the new objects, holding down the Shift key or the Control key or using a selection widget to add the new objects to the selection. If the new objects are to be added directly from fields of the database, a Field Chooser may be used.

The new objects may be added to a group by a designer interface, a “duplicate object” operation, a cut-and-paste operation, or other operation. For example, a designer interface may include a Field Chooser that allows a designer to select new objects from a group of available fields.

Each new object that may be added to the layout grouping may be added wherever a cursor controlled by a mouse happens to be hovering. The designer may select where within a view each new object is to be added by moving the mouse, and thereby moving the cursor over a desired location within the view.

When a single new object or an ordered list of new objects is added to the layout grouping, then each new object is added as near as possible to a mouse hover location without overlapping any object that may be within the view. If a mouse hover location is at a left half of an object, then each new object may be added to the left of the object and to the left of any previously added objects. If a mouse hover location is at a right half of an object, then each new object may be added to the right of the object and to the right of any previously added new objects.

As each new object is added to the layout grouping, it may inherit new properties from the layout grouping. Properties include, for example, gridline formatting, left padding, top padding, right padding, bottom padding, left margin, top margin, right margin, bottom margin, font face, font size, font weight, fore color, back color, border style, border color, border thickness, special effect, text align, font underline, font italic, reading order, scroll bar align, and/or line spacing. As each new object is added to the layout grouping, it may inherit all properties that do not conflict with any inheritable property of any other object of the layout grouping. For example, height and width of an object may be updated to conform with objects that already belong to the layout grouping.

If desired, gridlines are reapplied in response to a field (that is, an object) being added. The gridlines are applied as last specified. Other properties, such as gridline formatting, left padding, top padding, right padding, bottom padding, left margin, top margin, right margin, bottom margin, font face, font size, font weight, fore color, back color, border style, border color, border thickness, special effect, text align, font underline, font italic, reading order, scroll bar align, and/or line spacing are also reapplied as last specified.

The layout grouping may be updated to include the new objects before the ordinal values are assigned and before the layout grouping is aligned or adjusted. The new objects are added to the layout grouping and to the view such that the layout grouping includes the plurality of new objects. The new objects may be added to the group, before the ordinal values are assigned. Accordingly, all objects in the layout grouping, including the new objects, have equal priority when the ordinal values are assigned, and therefore the ordinal values are assigned without regard to which objects are new and which objects are not new. In other words, all of the objects in the layout grouping, including the new objects, are moved and/or resized as necessary to implement the desired layout grouping without regard to which objects are new objects.

The ordinal values can be changed without breaking the consistency of object placement. Reordering may be accomplished through a simple drag and drop operation which raises or lowers the ordinal value of a grouping within the layout.

New objects may be added even if no object is selected. FIG. 2 is a blank (new) view to which a plurality of objects, including objects set forth in a Field Chooser 208, may be added. The objects that are set forth in the Field Chooser 208 include an ID field, a Spec Name field, a Spec Body field, a Modified field, a PM field, a LocalMod field, a Dev field, a Test field, a Milestone field, a Spec Object field, and a Status field. The fields that are selected by the designer for adding to the view cause objects to be created.

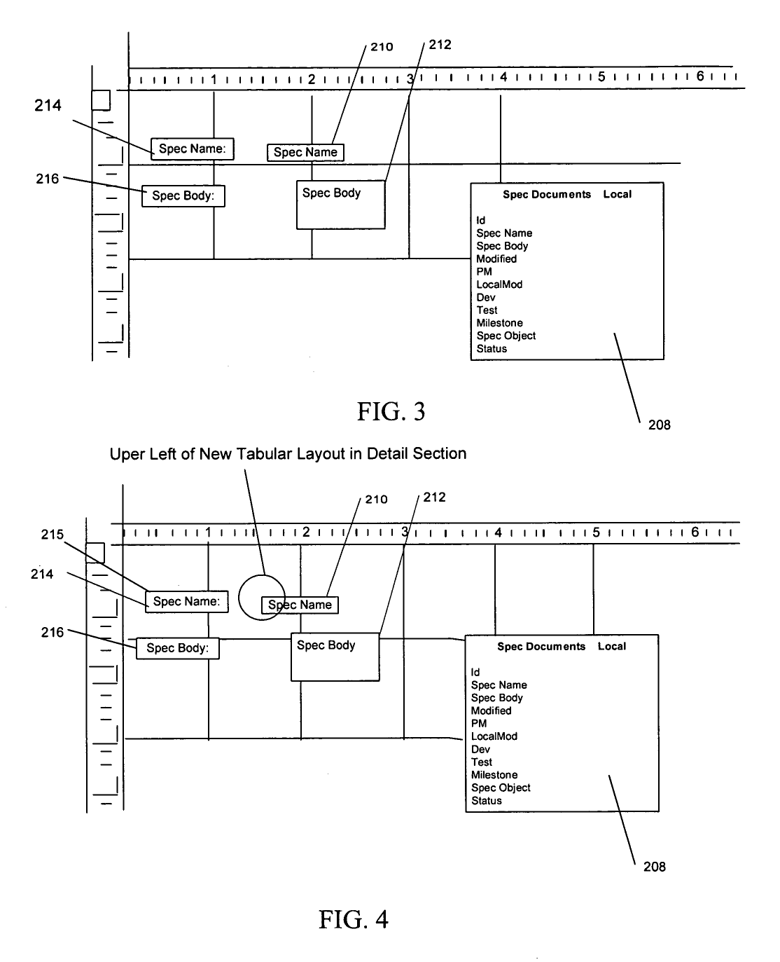

FIG. 3 is a diagram of screens in which a plurality of objects has been added to the blank (new) view of FIG. 2. The plurality of objects includes a first textbox identified as the Spec Name object 210 and a second textbox identified as the Spec Body object 212, each of which has a. label corresponding thereto. Accordingly, the view contains a Spec Name object 210, a Spec Body object 212, a Spec Name label 214, and a Spec Body label 216, which have already been added to the view by using the Field Chooser 208. In FIG. 3, the layout grouping may be added to the view.

### Discontiguous Objects

The objects of the layout grouping need not have any property in common. The objects need not belong to the same view, table, section, row, or column, and need not be bound to data within the same file.

### Determining Layout Grouping Preferences and “RTL” (“Right-To-Left”) Preferences

Once a layout grouping has been selected, a desired layout grouping may be determined. The desired layout grouping may be tabular or may be stacked. The desired layout grouping may be determined from a context, by a designer interface, or by a preference list, or by other means. For example, a default may be set within an application or within a Preferences file. The default may impose a desired tabular structure, such that each table that may be created may be tabular. The designer may modify the Preferences file to establish a preference for stacked tables; thereafter, all tables would be stacked.

Right To Left (“RTL”) positioning is a feature of all localized Microsoft products which allows for languages which display in the opposite direction from English (e.g. Arabic) to be displayed appropriately according to their locale. The layout system is flexible and can be adjusted to deal with locale variations as pertains to text display.

Even if a Preferences file has been created and even if the Preferences file indicates a desired layout grouping as a default, the designer may be able to override the default if the designer desires a stacked structure, and in the absence of such an override the tabular structure may be used.

In either situation, a designer interface may simply ask the designer which layout grouping is desired. The designer may be required to indicate the designer's preference for the layout grouping. The designer interface may be a GUI, a pop-up list or radio buttons, or some other designer interface.

Other approaches to determining a desired layout grouping may be used. The objects themselves may have shapes that can be used to determine a desired layout grouping. For example, a large number of horizontally-wide and vertically-short objects may fit within a view more easily when organized in a stacked table. Similarly, a large number of vertically-tall and horizontally-narrow objects may fit within a view more easily when organized in a tabular table.

In addition to the desired layout grouping, an RTL (Right to Left) property for the layout grouping may be determined. The RTL property may be imposed by a default, or may be imposed by an application running in software, or may be read from the Preferences file. The default may impose, for example, an RTL property value of “false.” The designer may be able to override the default if the designer desires to create a right-to-left table. A designer whose primary language is read from right to left may obtain a version of the application or may set the Preferences file such that the default imposes an RTL property value of “true.”

The RTL property of a layout grouping may be obtained by an examination of the layout grouping's objects themselves. For example, some objects may have an RTL property that exists and is set to “true,” while other objects either lack an RTL property or have an RTL property that is set to “false.” An example is a graphical image of a left-pointing arrow, which can be used to indicate “Next” for designers accustomed to languages that are read from right to left, and which can be used to indicate “Back” for designers accustomed to languages that are read from left to right. The layout grouping may include some objects for which the RTL property may be important, and other objects that do not have an RTL property.

If desired, the property of each object of a layout grouping may be examined and a “vote” taken, such that the all objects are assigned an RTL property that is set to “true” whenever a majority of the objects have an RTL property that is set to “true,” and such that the all objects are assigned an RTL property that is set to “false” (or such that the RTL property is deleted) whenever a minority of the objects have an RTL property that is set to “true.” The layout grouping, as a group, may thus be assigned an RTL property.

### Assigning an Ordinal Value

Once a layout grouping has been defined, and any new objects have been assigned to the layout grouping, each object in the layout grouping may be assigned an ordinal value. The ordinal value may be used to determine which object among overlapping objects may be moved, such that the overlapping objects no longer overlap; the object having a higher ordinal value may be moved downward, or to the right (or to the left, if the layout grouping has an RTL property that is set to “true), until any overlapping is resolved. The ordinal value may be assigned to each object of the layout grouping, regardless of a data type, in accordance with the position of the object in a first direction. An anchor point may be chosen for each object of the layout grouping, and the anchor points are compared. If the layout grouping does not have an RTL property or if the layout grouping has an RTL property that is “false,” then the ordinal values are assigned such that each object has a greater ordinal value than any object to its left. The object having the lowest ordinal value may be the leftmost of the objects belonging to the layout grouping.

If the layout grouping has an RTL property that is “true,” then the ordinal values are assigned such that each object has a greater ordinal value than any object to its right. The object having the lowest ordinal value may be the rightmost of the objects belonging to the layout grouping.

If the anchor points of any two or more objects have identical horizontal coordinates, then the object having the higher vertical position may be assigned a lower ordinal value. If the anchor points of any two or more objects have identical horizontal coordinates and also have identical vertical coordinates, then the object that is “encountered” first may be assigned a lower ordinal value. An object may be encountered first if it has a lower index.

It should be noted that in one embodiment any objects that are labels are not assigned ordinal values. Objects that are not labeled do not belong to the layout grouping. The ordinal value that may be assigned to each object may be relative to other objects of the layout grouping. For example, if one non-label object is closer than any other non-label object to a left edge of the view, then it may be assigned a lowest ordinal value. If more than one object is equally close to the left edge of the view, the object that is closest to a top edge is assigned the lower (or lowest) ordinal value. If the layout grouping has an RTL property that is “true,” then the object that is closer than any other to a right edge of the view may be assigned the lowest ordinal value. If more than one object is equally close to the right edge of the view, the object that is closest to a top edge may be assigned the lower (or lowest) ordinal value.

Based upon the anchor point of the object that is assigned the lowest ordinal value, a guide point may then be calculated. The location of the guide point may be equal to the location of the anchor point of the object having the lowest ordinal value. The location of the guide point may remain constant until it is recalculated; the aligning and the minimally adjusting of the objects does not affect the guide point, which stores a position of the object having the lowest ordinal value.

FIG. 4 is a diagram of a screen, showing a selection of controls from which to create layout grouping. The anchor point 215 has been found by examining the upper-left corners of each of the objects. The Field Chooser 208 may be used in conjunction with the tabular format, such that objects are added while the tabular table format is indicated. Of the two objects (Spec Name object 210 and the Spec Body object 212) that are not labels, the Spec Name object 210 may be closer than any other non-label object to a left edge of the view. Therefore, the Spec Name object 210 may be assigned the lowest ordinal value, and the upper-left comer of the Spec Name object 210 defines the anchor point 215.

### Linearly Aligning

Once a layout grouping (including any new objects) has been defined and each object of the layout grouping has received an ordinal value, then the layout grouping may be linearly aligned along a line that may be in a first direction. For example, if the layout grouping is tabular, the layout grouping may be linearly aligned along a horizontal line. The horizontal line to which the layout grouping is aligned may be selected to require a “best fit.” The best fit may be, for example, the line that requires the least mean square adjustment to the vertical position of each object in the layout grouping. Accordingly, the objects are shifted slightly in a vertical direction, either up or down, until the objects are in a horizontal line. If a line “wraps”; i.e. has too many objects for one line in the view, then the view may be expanded to accommodate the objects.

Unless the designer has established a contrary preference, each object of the layout grouping may be adjusted such that its top is along the horizontal line. The designer may establish a contrary preference, for example, that each object of the layout grouping be adjusted such that its center may be along the horizontal line or such that its bottom may be along the horizontal line.

If the layout grouping is stacked, the layout grouping may be linearly aligned along a vertical line. The vertical line to which the layout grouping is aligned may be selected to require a “best fit.” The best fit may be, for example, the line that requires the least mean square adjustment to the vertical position of each object in the layout grouping. Accordingly, the objects are shifted slightly in a horizontal direction, either left or right, until the objects are in a vertical line.

Unless the designer has established a contrary preference, each object of the layout grouping may be adjusted such that its left edge is along the vertical line if the RTL property of the layout grouping is not “true,” and such that its right edge is along the vertical line if the RTL property of the layout grouping is “true.” The designer may establish a contrary preference, for example that each object of the layout grouping be adjusted such that its center may be along the vertical line.

### Minimally Adjusting

Tabular layout is achieved by automatically adjusting the objects so that they go from a perhaps disorganized or jumbled layout to a table-like layout where the objects appear to be arranged in columns and/or rows. More specifically, once the objects are in a line, whether the line is horizontal or vertical, each object in the layout grouping may be automatically adjusted in position to avoid overlap among the objects of the group. The adjustment may be made regardless of the data type of the object. The position of the object may be adjusted such that the object does not overlap any other object of the layout grouping having a lower ordinal value. The objects are thus non-overlapping with a minimum distance there-between.

The adjustment may operate differently for tabular and stacked tables. Specifically, if the desired layout grouping is the stacked type, then the adjustment may be vertically downward. The position of the object may be minimally adjusted downward, such that the object does not overlap any other object of the layout grouping having a lower ordinal value.

If the desired layout grouping is the tabular type, then the adjustment may also depend on the RTL property. For example, if the desired layout grouping is tabular and the layout grouping either has no RTL property or has an RTL property that is “false,” then the first direction may be horizontally rightward. Each object may be adjusted rightward until it does not overlap any other object having a lower ordinal value. The position of the object may be minimally adjusted to the right.

If the desired layout grouping is tabular and the layout grouping has an RTL property that is “true,” then the first direction may be horizontally leftward. Each object may be adjusted leftward until it does not overlap any other object having a lower ordinal value. The position of the object may be minimally adjusted to the left.

The position of the control group (and of each other control group containing an object having a higher ordinal value) may thus be minimally adjusted in the first direction, or in the second direction opposite to the first direction if at least one object within the control group has a true RTL property. No object of the control group overlaps any other object of the layout grouping having a lower ordinal value. The label object may thereafter be rearranged when the object is rearranged.

### Control Groups, Including Header Groups

After the desired layout is imposed on the layout grouping by the adjusting of their positions, the objects of the layout grouping are assigned to control groups. A control group is either a row of objects or a column of objects. If the desired layout grouping is tabular, the layout grouping may be regarded as a row, and each individual object of the layout grouping may be regarded as belonging to a column. If the desired layout grouping is stacked, the layout grouping may be regarded as a column, and each individual object of the layout grouping may be regarded as belonging to a row. Rows and columns are examples of control groups.

Although in one embodiment none of the objects of the layout grouping is a label, any of the objects may have a label. A label may be an object that is associated with another object. For example, a video, graphic, icon, file, folder, or other object may have a title, caption, or other label; the title, caption or other label corresponds to the video, graphic, icon, file, folder or other object. The label is an object, but is ancillary to the object of the layout grouping, and may be moved, deleted, cut, resized, or duplicated whenever the object with which it is associated is moved, deleted, cut, resized, or duplicated. The labels are not considered objects of the layout grouping described supra. Each label may have a position near the object with which it is associated.

The positions of labels may be adjusted in response to adjustment of the position of objects with which they are associated. Specifically, if at least one object of the layout grouping has a label but the layout grouping has no header group, then the header group may be created for the layout grouping. The header group is intended to accommodate the label or labels of the layout grouping. The header group may be created such that it is parallel to the line to which the objects of the layout grouping are aligned. If the objects of the layout grouping are aligned along a horizontal line, then the header group may be created to be along another horizontal line. In other words, if the objects of the layout grouping are aligned along a vertical line, then the header group may be created to be along another vertical line.

Each object of the layout grouping may be examined when laying out the objects to determine whether it has a corresponding label object, and whether it has a label. If an object has a label but no corresponding label object, then the label may be disassociated from the object, converted into a corresponding label object, and assigned default label properties from a toolbox. Whichever of the object and the corresponding label object is narrower is then resized, such that the object and the corresponding label object have a common width. A control group may be then created to include both the object of the layout grouping and the corresponding label object. Although the label may not be assigned an ordinal value, it may be moved in accordance with the object with which it is associated.

Each object for which a corresponding label object is created may then be aligned with the corresponding label object, along a control group line that is perpendicular to the first direction. In other words, if the objects are aligned along a horizontal line, then each corresponding label object for each object may be aligned vertically over the object. The corresponding label object may be directly above the object of the layout grouping when the line in the first direction is horizontal.

If the objects are aligned along a vertical line (for example, in a stacked table), then each corresponding label object for each object may be aligned horizontally. The corresponding label object may be aligned horizontally to the left of the object when the layout grouping has no RTL property or when the layout grouping has an RTL property that is “false,” and may be aligned horizontally to the right of the object when the layout grouping has an RTL property that is “true.”

### Inheriting Properties

If the line in the first direction is horizontal, then the header group may be examined to determine a maximum header object height. Once the maximum header object height has been determined, then a height of each object within the header group shorter than the maximum header object height may be increased. All objects within the header group are thus of uniform height.

If the line in the first direction is vertical (i.e., in a stacked table in which the header group is along a left edge or a right edge of the table), then the header group may be examined to determine a maximum header object width. Once the maximum header object width has been determined, then a width of each object within the header group narrower than the maximum header object width may be increased. All objects within the header group are thus of uniform width.

Once the header group has been created, it must be positioned appropriately within the view. A preferred distance between the header group and the layout grouping may be determined, and the preferred distance may be assigned as an inheritable property of the layout grouping. Either the layout grouping is linearly aligned as a first row, and the header group is linearly aligned as a second row parallel to the first row, or the layout grouping is linearly aligned as a first column, and the header group is linearly aligned as a second column.

If the layout grouping includes a first object of a first control group and a second object of a second control group, a new control group may be created containing all objects of the first control group and all objects of the second control group. The new control group may be in the first direction of the first control group. In other words, the new control group may be to the right of the first control group if the first direction is to the right, to the left of the first control group if the first direction is to the left, above the first control group if the first direction is upward; and below the first control group if the first direction is downward.

It may be desired that all objects in the control group share as many properties as possible. Whenever a property of an object within the layout grouping is modified, a corresponding property of each object of the layout grouping may be modified as well. The modified property may be propagated into all other objects within the layout grouping.

Some properties that may be inherited include a height property and a width property. It may be desired that all objects within a row have a uniform height, although each row may have a height that is different from the height of another row. It may also be desired that all objects within a column have a uniform width, although each column may have a width that is different from the width of another column.

Modified properties may include height and width. Each row and/or column may be resized by dragging a resizer such as a line that is between adjacent control groups. For example, a designer may horizontally drag a resizer such as a vertical line between adjacent objects of the row. If at least one column is to the left of the resizer and the table has no RTL property set to “true,” then a column width of a column immediately to the left of the resizer may be adjusted in accordance with the horizontal dragging, and all columns to the right of the resizer are repositioned without being resized. The designer may be prohibited from dragging the resizer beyond any other resizers that may be to its left; dragging of the resizer may be limited such that the column width remains greater than zero. Similarly, if at least one column is to the right of the resizer and the table has an RTL property set to “true,” then a column width of a column immediately to the right of the resizer may be adjusted in accordance with the horizontal dragging, and all columns to the left of the resizer are repositioned without being resized. The designer may be prohibited from dragging the resizer beyond any other resizers that may be to its right; dragging of the resizer may be limited such that the column width remains greater than zero.

On the other hand, if the table includes a resizer such as a horizontal line between adjacent objects of a column (e.g., a bottom-border or top-border of a cell), a designer may vertically drag the resizer. If at least one row is above the resizer, then a row height of a row immediately above the resizer may be adjusted in accordance with the vertical dragging, and all rows below the resizer are repositioned without being resized. The designer may be prohibited from dragging the resizer beyond any other resizers that may be above it; dragging of the resizer may be limited such that the row height remains greater than zero.

### Relative Position

Once the objects have been aligned and minimally adjusted, each object has a relative position. The relative position of each object may be regarded as a vertical distance and a horizontal distance between the anchor point 215 of the object and an anchor point 215 of an object having a lower ordinal value in the control group. The position of each object may be thus defined in terms of a position of an object having a lower ordinal value.

The object having the lowest ordinal value (regardless of whether the control group is tabular or stacked, and regardless of whether the control group has an RTL property that is true) may then be moved, such that the anchor point 215 of the object having the lowest ordinal value coincides with the guide point. Since all other objects have a relative position rather than an absolute position, each of the other objects may be moved accordingly, to maintain the relative position.

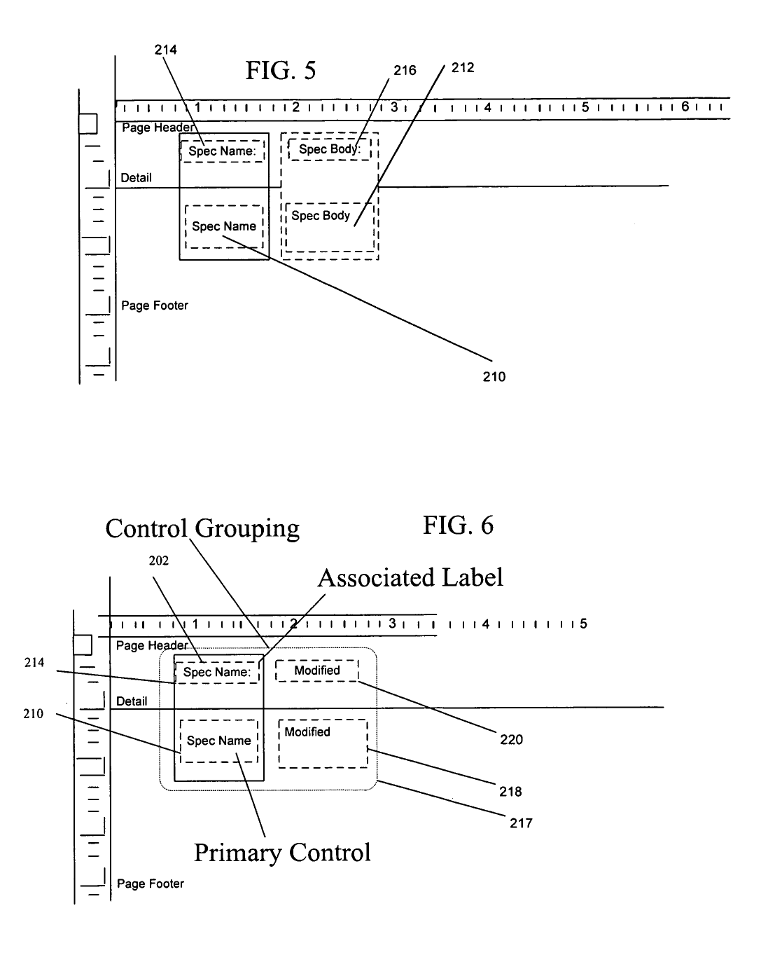

FIG. 5 is a diagram of a screen depicting a creation of a layout grouping. A first object, i.e. a textbox identified as “Spec Name,” (Spec Name object 210) may be located such that its upper-left comer (i.e., its anchor point) is located at a guide point. A second object, i.e. a textbox identified as “Spec Body” (Spec Body object 212) may be located such that its upper-left corner (i.e., its anchor point) maintains a relative position with respect to the anchor point of the first object (Spec Name object 210). A Spec Name label 214, corresponding to the first object and identified as “Spec Name,” and a Spec Body label 216, corresponding to the second object and identified as “Spec Body,” have been placed into a header row that is located above the guide point.

Each object that has a label corresponding thereto may be regarded as forming a control grouping with the label corresponding thereto. If the layout grouping is tabular, then the control grouping may be a column. If the layout grouping is stacked, then the control grouping may be a row.

FIG. 6 is a diagram of a screen depicting components of a layout grouping. A first object, i.e. a textbox identified as “Spec Name,” (Spec Name object 210) may be located such that its upper-left corner (i.e., its anchor point) may be located at a guide point. A second object, i.e. a textbox identified as “Modified” (Modified object 218) may be located such that its upper-left corner (i.e., its anchor point) maintains a relative position with respect to the anchor point of the first object (Spec Name object 210). A Spec Name label 214, corresponding to the first object and identified as “Spec Name,” and a Modified label 220, corresponding to the second object and identified as “Modified,” have been placed into a header row that is located above the guide point.

Each object that has a label corresponding thereto may be regarded as forming a control grouping with the label corresponding thereto. If the layout grouping 217 is tabular, then the control grouping may be a column. If the layout grouping 217 is stacked, then the control grouping may be a row.

### Absolute Position

The position of each object within a layout grouping 217 or within a view may be stored either as an absolute position or as a relative position. The position of each object may be calculated as a relative position and converted to an absolute position. If data are to be exported to another application, such as a legacy version of Microsoft Access, which requires that the position of each object be stored as an absolute position, then all relative positions may be converted to absolute positions during the exporting.

### Table Manipulation: Grouping

Once the objects have been assigned ordinal values, aligned, and minimally adjusted, and once properties have been inherited, control groups such as rows, headers, and table sections have been created, and any header groups have been created, control groups may be selected or multi-selected using a selection metaphor similar to that of Microsoft Word tables and Microsoft Excel spreadsheets.

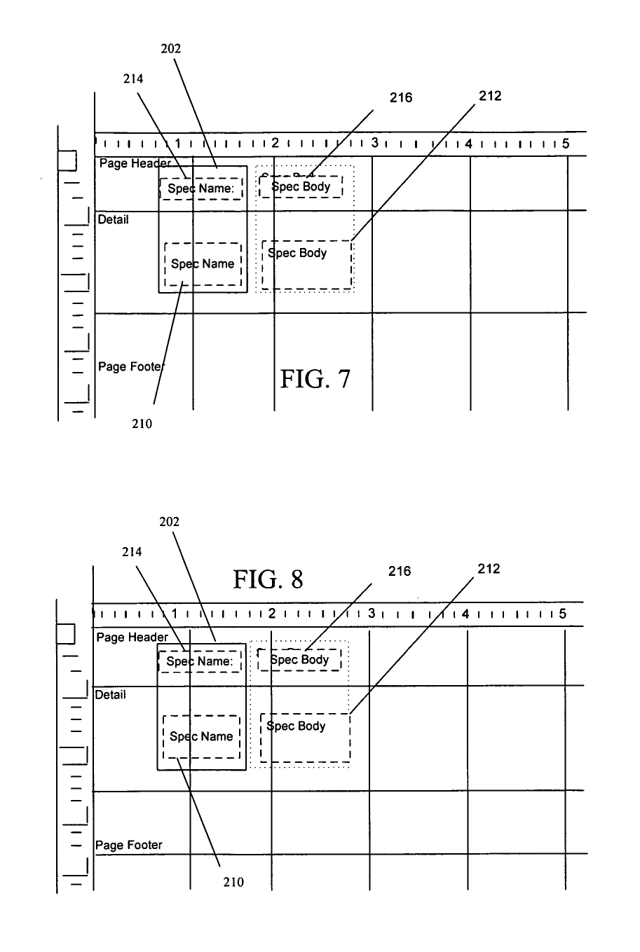

FIG. 7 is a diagram of a screen showing a selection of a control (the Spec Name object 210) in a row of a table having a tabular table format. The object has a label corresponding thereto, i.e. the Spec Name label 214. A selection widget 202 encloses both the Spec Name object 210 and the Spec Name label 214 corresponding thereto. The table has a tabular table format, and therefore the label corresponding to the object may be positioned over the object itself. The Spec Body object 212 and the Spec Body label 216 are not selected, as shown by the fact that the selection widget 202 does not enclose these objects. Selection of the object also selects the label. FIG. 7 also reveals that selecting a control (that is, of an object) in a table having a tabular table format may be equivalent to selecting a column of the table, since each column has only the object and any label that may correspond thereto.

FIG. 8 is a diagram of a screen showing a selection of a column, i.e. a group of user-interface objects, within a view. The group of user-interface objects includes a control, i.e. the Spec Name object 210, and the label corresponding thereto, i.e. the Spec Name label 214, both of which are enclosed by the selection widget 202. Two other objects, i.e. the Spec Body object 212 and the Spec Body label 216, are not selected, and are not enclosed within the selection widget 202. The user-interface object resides within a table having a tabular table format. Since the object is in a table that has a tabular table format, the label corresponding thereto may be positioned above the object itself. Selection of the object also selects the label. Selecting a control (that is, of an object) in a table having a tabular table format may be equivalent to selecting a column of the table, since each column has only the object and any label that may correspond thereto.

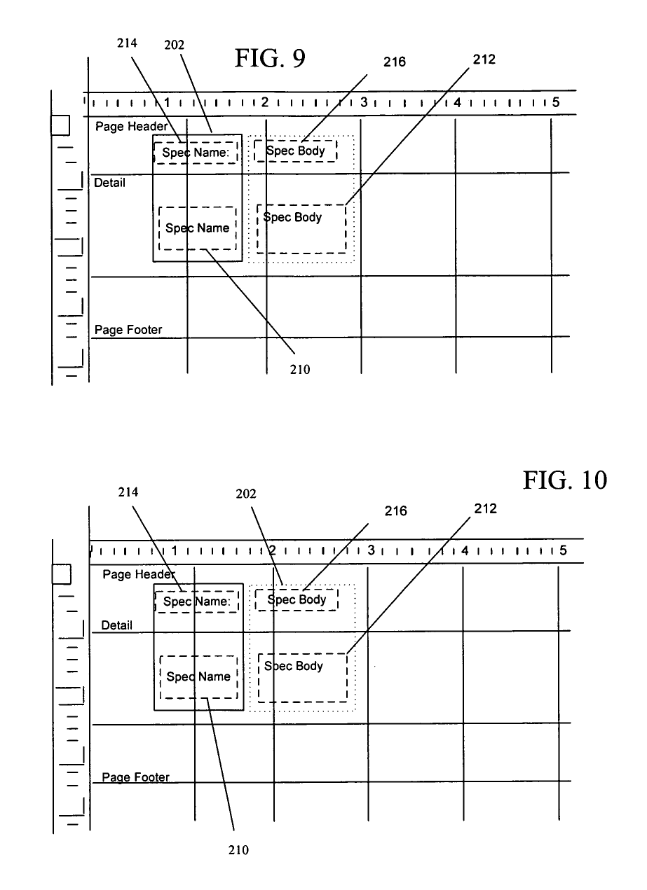

FIG. 9 is a diagram of a screen showing a selection of a row (that is, of a control group) of a table having a tabular table format (i.e., a col-wise layout). The row contains both the Spec Name object 210 and the Spec Body object 212, each of which has a label corresponding thereto. Since the objects are in a table that has a tabular table format, the labels corresponding thereto are positioned over the object itself. Selection of the row also selects the labels; therefore, the Spec Name label 214 and the Spec Body label 216 are enclosed within the selection widget 202 as well. The objects within the row are multi-selected.

FIG. 10 is a diagram of a screen showing a selection of a table. The table includes only one row of objects (and a header row of labels corresponding to the row of objects), and therefore appears similar to the screen of FIG. 9, in which only one row of objects (and the header row corresponding thereto) is selected. FIG. 10, however, shows a selection of a table, while FIG. 9 shows selection of a row within a table. Accordingly, an entire table may be regarded as a layout grouping. The table includes a Spec Name object 210, having a Spec Name label 214 corresponding thereto, and a Spec Body object 212, having a Spec Body label 216 corresponding thereto. The table has a tabular table format. Since the Spec Name object 210 and the Spec Body object 212 are in a table that has a tabular table format, the Spec Name label 214 and the Spec Body label 216 are each positioned over its corresponding object. Selection of the row also selects the labels. As shown in FIG. 10, a selection widget 202 encloses the Spec Name object 210, the Spec Body object 212, the Spec Name label 214 and the Spec Body label 216. The objects within the table are multi-selected.

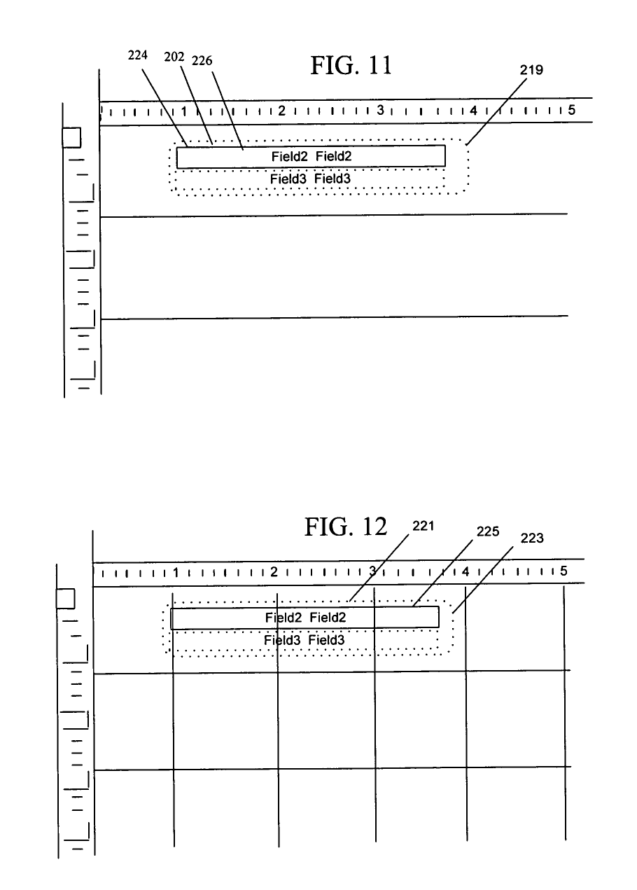

FIG. 11 is a diagram of a screen showing a selection of a group of user-interface objects within a view. The group of user-interface objects includes a control (that is, an object 226) and a label 224 corresponding thereto. The user-interface object resides within a table 219 having a stacked table format, and either no RTL property or an RTL property that is set to “false.” Since the object may be in a table 219 that has either no RTL property or an RTL property that is set to “false”, the label corresponding thereto may be positioned to the left of the object itself. Selection of the object also selects the label. As shown in FIG. 11, a selection widget 202 (dashed lines) encloses both of the selected user-interface objects. Selecting a control (that is, an object) in a table 219 having a stacked table format may be equivalent to selecting a row of the table 219, since each row has only the object and any label that may correspond thereto. Since the object 226 may be in a table 219 that has either no RTL property or an RTL property that is set to “false”, the label 224 corresponding thereto may be positioned to the left of the object itself. Selection of the object 226 also selects the label 224. FIG. 11 also reveals that selecting a control (that is, an object such as the object 226) in a table 219 having a stacked table format may be equivalent to selecting a row of the table 219, since each row has only the object and any label that may correspond thereto.

FIG. 12 is a diagram of a screen showing a selection of a column 221, (that is, of a control group) of a table 223 having a stacked table format. Each object has a label corresponding thereto. Since the object may be in a table 223 that has either no RTL property or an RTL property that is set to “false”, the label corresponding thereto may be positioned to the left of the object itself. Selection of the row also selects the labels. As shown in FIG. 12, a selection widget 225 encloses both the object and the label corresponding thereto. The objects within the column 221 are multi-selected.

### Table Manipulation: Resizing

The control groups such as rows, columns, sections and tables are also available to be resized using a metaphor similar to metaphors of Microsoft Word tables and Microsoft Excel spreadsheets.

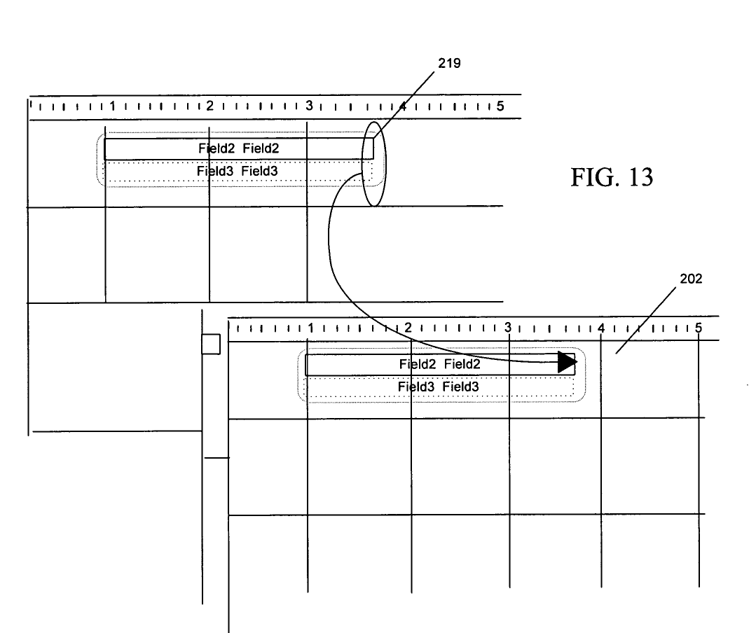

FIG. 13 is a screen showing a resizing of columns in a table having a stacked tabular layout. In an upper portion of FIG. 13, layout selector widget placement (for example, using a drag operation of a mouse and cursor) places a selection widget 202 around a row of a table. The selection widget 202 includes eight dots, located at the corners of the selection widget 202 and midway along each line segment of the selection widget 202. The dots are resizers, including both horizontal resizers and vertical resizers. A designer may select any of the eight handles on the selection widget 202 that surrounds the periphery of the selected objects, and may resize the objects by dragging the handle.

In a lower portion of FIG. 13, the row of the table has been resized. The row has a width property that may then be inherited into each other row of the table.

### Moving Control Groups

Each row may be positioned relative to other rows, and each column may be positioned relative to other columns. Positioning of a row or a column may be accomplished by dragging. In other words, a row or column may be dragged to another position in the table, and the rows and columns will be re-ordered accordingly.

A row may be dragged by vertically dragging any object of the row. The row may be dragged into or beyond any other row of the table. If the desired layout grouping is stacked, then vertically dragging a row may require re-assigning ordinal values to the objects of the table, since each row contains only one object of the layout grouping; the table may be organized such that each object of the layout grouping is assigned to a distinct row. If a row is dragged into or beyond another row of the table such that the ordinal values of the objects are re-assigned, then each row having at least one object whose ordinal value may be altered by the vertical dragging of the row may be automatically redrawn to eliminate overlap among the rows.

A column may be dragged by horizontally dragging any object of the column. The column may be dragged into or beyond any other column of the table. If the desired layout grouping is tabular, then each column contains only one object of the layout grouping; the table may be organized such that each object of the layout grouping may be assigned to a distinct column; accordingly, horizontally dragging a column may require re-assigning ordinal values to the objects of the table. If a column is dragged into or beyond another column of the table such that the ordinal values of the objects are re-assigned, then each column having at least one object whose ordinal value is altered by the horizontal dragging of the column may be automatically redrawn to eliminate overlap among the columns.

### Modifying Properties

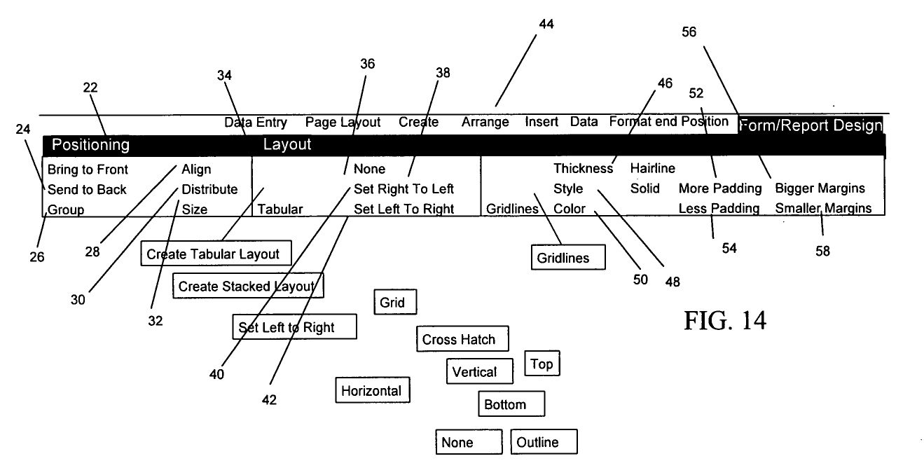

Properties may be inherited, but a designer may also modify properties of an object, a group, and/or a control group (such as a row, column, section, or table). FIG. 14 is a diagram of a screen of a Ribbon Command user-interface, i.e. a user interface implemented as a control bar. The Ribbon Command user-interface includes a Bring to Front button 22 and a Send to Back button 24 that allow the designer to move selected objects to a different drawing layer. The Ribbon Command user-interface also includes a Group button 26 that allows the designer to group objects into a higher-abstraction object, an Align button 28 that invokes the alignment operation discussed above in the Linear Aligning section and that allows the designer to align the objects by left-edge, horizontal center, right-edge, top, middle, or bottom, or arranges the objects along a designer-defined line, at polygon vertices, or along a freeform shape. The Ribbon Command user-interface also includes a Distribute button 30 that allows the designer to adjust the positions of the objects to provide greater spacing or to force the objects into an equidistant spacing. A Size button 32 opens a dialog box that allows the designer to specify a default size for the selected objects.

A Tabular Layout button 34 allows the designer to force each table that contains at least one selected object into a tabular layout. The Tabular Layout button 34 is shown as enabled, indicating that at least one selected object resides within a table that is not in a tabular layout. A Stacked Layout button 36, if enabled, would allow the designer to force each table that contains at least one selected object into a stacked layout. The Stacked layout button 36 is shown as disabled, indicating that there may be no selected object in any stacked table. If desired, a “toggle layout grouping” function may be included. The toggle layout grouping function may be used when a designer determined that the layout grouping is no longer preferred, and desires to switch from a stacked table to a tabular table or vice-versa. The toggle layout grouping function may be accessed through a designer interface.

The Ribbon Command user-interface also contains a None button 38 that allows a designer to command an object be removed from the layout. In other words, all selected objects are deleted from the layout in response to a designer selecting the None button 38. The Ribbon Command user-interface also includes a Set Right To Left button 40 and a Set Left To Right button 42 that can create and set an RTL property (i.e., a “Right-To-Left” property) in each selected object, or in a layout grouping if a layout grouping is selected. Since the Set Left To Right button 42 is enabled, the layout grouping that are selected includes at least one object that has an RTL property set to “true,” and since the Set Right To Left button 40 is enabled, the layout grouping that are selected includes at least one object that either lacks an RTL property set or has an RTL property that is set to “false.”

The Ribbon Command user-interface may also contain a Gridlines button 44. As indicated above, the view may have gridlines and spacing between tables, rows, columns, sections, and cells; such properties may be implemented as a property of each table, row, column, cell, or object, or may be stored as a property of the layout itself. The Gridlines button 44 opens a dropdown menu of eight gridline formats, allowing the designer to set a gridline command property of the view (if no objects are selected), or of any selected objects (if at least one object is selected). Each gridline also has a line-style property which may be set to any of the following: transparent border, solid, dashes, short dashes, dots, sparse dots, dash-dot, dash-dot-dot, and double solid. Other properties of the Gridlines button 44 include a gridline color interface, a gridline thickness interface, a gridline thickness bottom, a gridline thickness left, and gridline thickness right.

Other buttons in the Ribbon Command user-interface allow the designer to access properties of any selected objects, or to set defaults for any new objects that may be created. For example, the Ribbon Command user-interface contains a Thickness dropdown menu 46, a Style dropdown menu 48, and a Color dropdown menu 50. The Ribbon Command user-interface also includes a More Padding button 52 and a Less Padding button 54 that allow the designer to increase or decrease, respectively, spacing between adjacent objects, and a Bigger Margins button 56 and a Smaller Margins button 58 that allow the designer to increase or decrease, respectively, margins between the selected objects and the left and top edge of the layout.

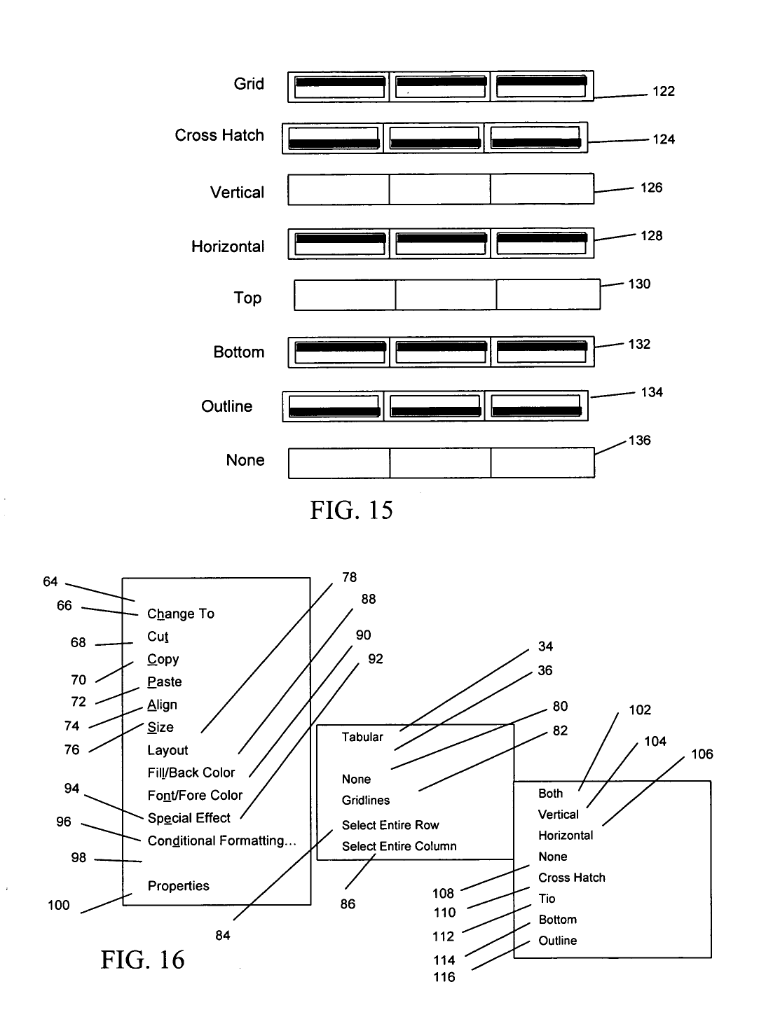

FIG. 15 shows several Gridlines Gallery Options. The Gridlines Gallery Options are available to the designer in response to a selection of the Gridlines button 44 of FIG. 14. The Gridlines Gallery Options include a Grid dropdown menu item 122, a Cross Hatch dropdown menu item 124, a Vertical dropdown menu item 126, a Horizontal dropdown menu item 128, a Top dropdown menu item 130, a Bottom dropdown menu item 132, an Outline dropdown menu item 134, and a None dropdown menu item 136.

FIG. 16 is a screen of a Context Menu command user-interface. The Context Menu command user-interface includes a Build dropdown menu item 64, a Change To dropdown menu item 66, a Cut dropdown menu item 68, a Copy dropdown menu item 70, a Paste dropdown menu item 72, an Align dropdown menu item 74 (which operates as the Align button 28 as shown in FIG. 14), and a Size dropdown menu item 76 (which operates as the Size button 32 of FIG. 14, opening a dropdown menu).

The Context Menu command user-interface also includes a Layout dropdown menu item 78. The Layout dropdown menu item 78 operates to open a dropdown menu to allow the designer to select either tabular layout (the selection of a tabular layout through the Layout dropdown menu item 78 being equivalent to clicking on either the Tabular Layout button 34 of FIG. 14) or stacked layout (the selection of a stacked layout through the Layout dropdown menu item 78 being equivalent to clicking on the Stacked Layout button 36 of FIG. 14). The Tabular Layout button 34 is enabled if the selection contains at least one object that resides in a table not formatted to a tabular layout, and the Stacked Layout button 36 of FIG. 14 is enabled if the selection contains at least one object that resides in a table not formatted to a stacked layout. The Layout dropdown menu item 78 also includes a None dropdown menu item 80, which operates as the None button 38 of FIG. 14; a Gridlines dropdown menu item 82 (which operates as the Grid dropdown menu item 122 of FIG. 15 and as the Gridlines button 44 of FIG. 14), a Select Entire Row dropdown menu item 84, and a Select Entire Column dropdown menu item 86.

The Context Menu command user-interface also includes a Fill/Back Color dropdown menu item 88, a Front/Fore Color dropdown menu item 90, a Special Effect dropdown menu item 92, a Conditional Formatting dropdown menu item 94, a Hyperlink dropdown menu item 96 (which is shown disabled), a Sub-report in New Window dropdown menu item 98, and a Properties dropdown menu item 100.

If the designer selects the Gridlines dropdown menu item 82 or the Gridlines button 44 of FIG. 14, a Gridline dropdown menu allows the designer to select either a Both dropdown menu item 102, which creates both vertical and horizontal gridlines within each selected object, group, row, column, section, or table, or the entire layout; a vertical dropdown menu item 104, which operates as the Vertical dropdown menu item 126 of FIG. 15 and which creates vertical but not horizontal gridlines within each selected object, group, row, column, section, or table, or the entire layout; a horizontal dropdown menu item 106 (which operates as the Horizontal dropdown menu item 128 of FIG. 15 and which creates horizontal but not vertical gridlines within each selected object, group, row, column, section, or table, or the entire layout); a None dropdown menu item 108, which operates as the None dropdown menu item 136 of FIG. 15 and which eliminates all gridlines within the selected object, group, row, column, section, or table or the entire layout; a Cross Hatch dropdown menu item 110 (which operates as the Cross Hatch dropdown menu item 124 of FIG. 15), which creates a cross-hatch gridline within each selected object, group, row, column, section, or table, or the entire layout; a Top dropdown menu item 112, which operates as the Top dropdown menu item 130 of FIG. 15 and which creates gridlines within a top section, such as a header group; a Bottom dropdown menu item 114, which operates as the Bottom dropdown menu item 132 of FIG. 15 and which creates gridlines within a Detail Section (that is, the section containing record data) of each table that contains at least one selected object; and an Outline dropdown menu item 116, which operates as an Outline dropdown menu item 134 of FIG. 15 and which creates an outline.

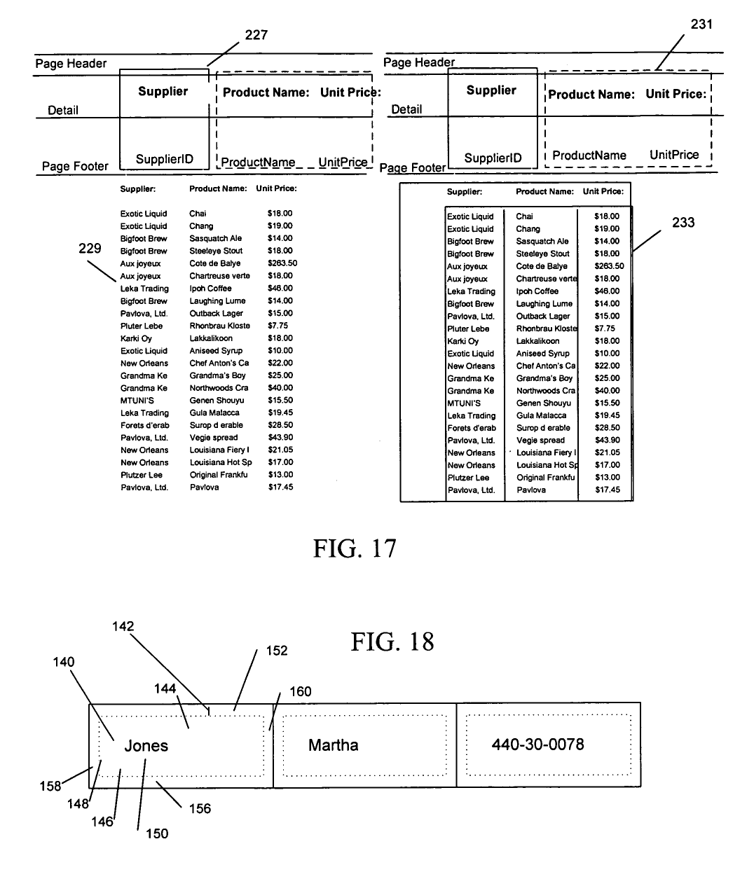

FIG. 17 is a diagram of a screen depicting an application of gridlines to a typical data set. Gridlines may help a user see relationships among objects of a row, column, or table. On a left side of FIG. 17, the data set is shown in Design mode 227 and in Browse mode 229. The data set is shown lacking gridlines. On a right side of FIG. 17, the data set is shown in Design mode 231 and in Browse mode 233. The data set is shown with both horizontal and vertical gridlines.

FIG. 18 is a partial screen layout depicting Margins 140 and Padding 142. The Margins 140 are shown interior to each object; a margin may be understood as a space between the object's contents and the border of the object. The Margins 140 include a Top Margin 144, a Bottom Margin 146, a Left Margin 148, and a Right Margin 150. The Padding 142 may be understood as similar to the Margins 140, except that the Padding 142 applies to objects that are a part of a layout, and are exterior to the object; the Padding 142 is between the object and any border that may be applied to the object. The Padding 142 includes a Top Padding 152, a Bottom Padding 156, a Left Padding 158, and a Right Padding 160, each of which has a default value of zero. When viewed as a datasheet, the Padding 142 is ignored and is not included. The Top Padding 152 and the Bottom Padding 156 are maintained to be the same for all objects horizontally aligned in one layout. The Left Padding 158 and the Right Padding 160 are maintained to be the same for all objects vertically aligned in a layout. The Padding 142 is not affected by moving or resizing objects in a layout.

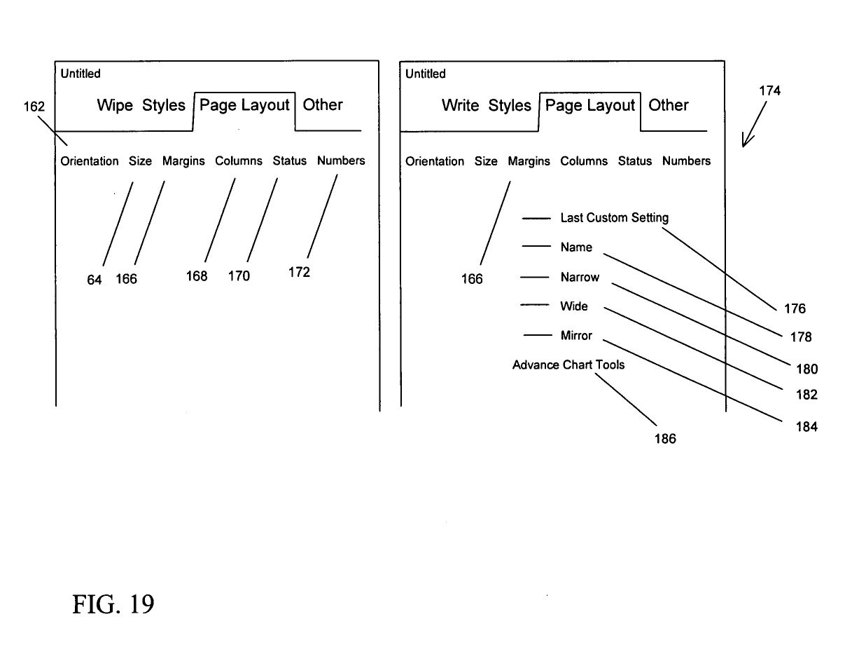

FIG. 19 is a diagram of a screen of a Margins Gallery. The Margins Gallery includes an Orientation button 162, a Size button 164, a Margins button 166, a Columns button 168, a Breaks button 170, and a Numbers button 172. In response to a click on the Margins button 166, a Margins dropdown menu 174 opens. The Margins dropdown menu 174, a Last Custom Setting button 176, a Normal button 178, a Narrow button 180, a Wide button 182, a Mirrored button 184, and an Advanced Chart Tools dropdown menu 186 are also available.

In response to a click on the Last Custom Setting button 176, each margin of each selected object is set to an updatable value stored within a preferences list. A top margin, a bottom margin, a left margin, and a right margin of each object is reset to conform to a last custom setting preference. In response to a click on the Normal button 178, each margin of each selected object is set to an updatable value stored within a Normal template. In response to a click on the Narrow button 180, each margin of each selected object is set to a value of 1 px (i.e., one pixel). In response to a click on the Wide button 182, each margin of each selected object is set to a value of 6 px (i.e., six pixels). Additional buttons such as a None button (not shown) and a Medium bottom (also not shown) are operative to set the value of each margin of each selected object to 0 px (i.e., zero pixels) and 3 px (i.e., three pixels) respectively.

### Inserting a Column

After a layout grouping has been arranged as a table, additional objects may be added to the table. If the table has a table format that is tabular, each object that is subsequently added to the table becomes a column of the table. If the table has a table format that is stacked, each object that is subsequently added to the table becomes a row of the table.

If desired, the designer may be notified where any new objects may be positioned. A graphical device, such as a vertical line intersected by a horizontal line or cross-hash can show a designer where a next-to-be-added object will be positioned.

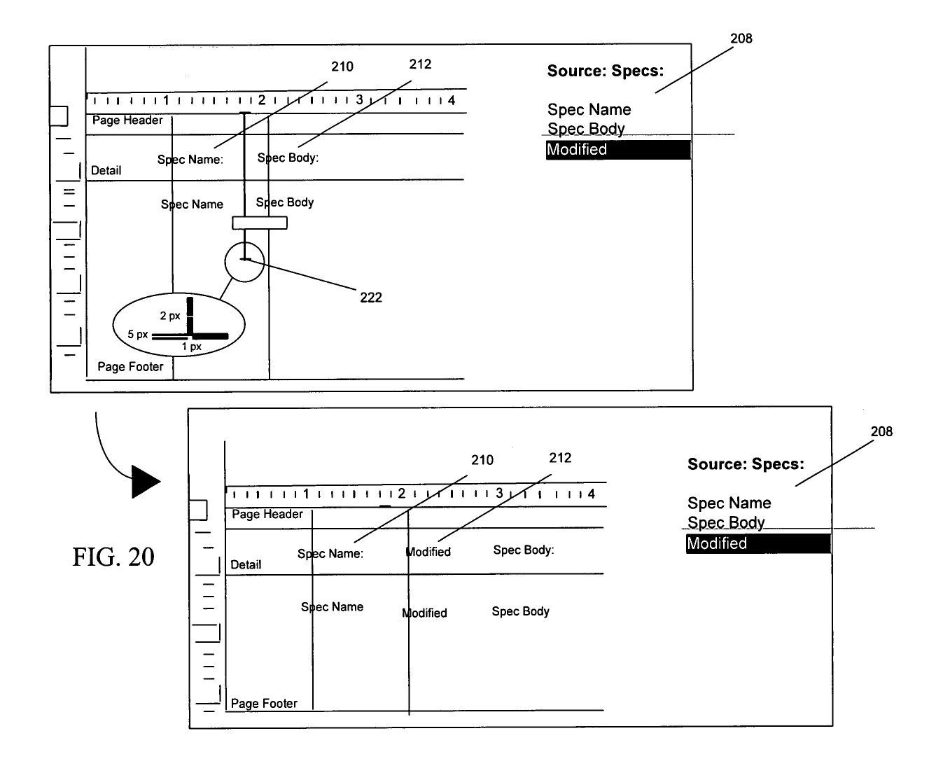

FIG. 20 is a diagram of a screen in which an object is added to a table that has a tabular table format. As shown in an upper portion of FIG. 20, the table already contains two objects, identified as a Spec Name object 210 and a Spec Body object 212. Each of the two objects has a label corresponding thereto. A Field Chooser 208 provides the designer with a tool for adding an additional object, or several additional objects, to the table. The Field Chooser 208 indicates that the designer may add an ID object, a duplicate Spec Name object, a duplicate Spec Body object, and/or a Modified object. A Modified field is highlighted, indicating that the designer intends to add the Modified object to the table. The table has a page header that contains the labels of the objects of the table, and a page footer.

A vertical line 222 intersected by a cross-hash shows the designer where the next-to-be-added object is to be positioned. The vertical line 222 is used instead of a horizontal line, since the table has a tabular table format; if the table has a stacked table format, a horizontal line is used to show the designer where the next-to-be-added object is to be positioned. The vertical line 222 is blue, and has a width of two pixels.

In the example shown in FIG. 20, the object to be added has a label corresponding thereto. Since the table has a tabular table format, the label corresponding to the object is to be added above the object itself. If the table has a stacked table format, then the label corresponding to the object would be added to the left of the object itself unless the object has an RTL property set to “true,” in which case the label corresponding to the object would be added to the right of the object itself.

Since table format is tabular, adding an object to a layout grouping is equivalent to adding a new column to the table. The new column is to contain the object and its corresponding label. A first cross-hash and a second cross-hash, each having a width of one pixel, show an upper boundary and a lower boundary of the new column, respectively. A central cross-hash shows where any text of the object will be positioned.

As shown in a lower portion of FIG. 20, a column has been created within the table. The column is created where the vertical line 222 indicates, and contains an object and a label corresponding thereto. The object is added to the table, the object is added to the row, and the label is added to the header group. The new column is selected.

### Incorporating a Control Into a Grouping

If a table is selected and an object (or multiple objects) not of the table is also selected, the object (or multiple objects) may be incorporated into the table by grouping the object (or multiple objects) with the table. The object (or multiple objects) inherits many of the properties of objects already belonging to the table, including height (if the table has a tabular format) and width (if the table has stacked format).

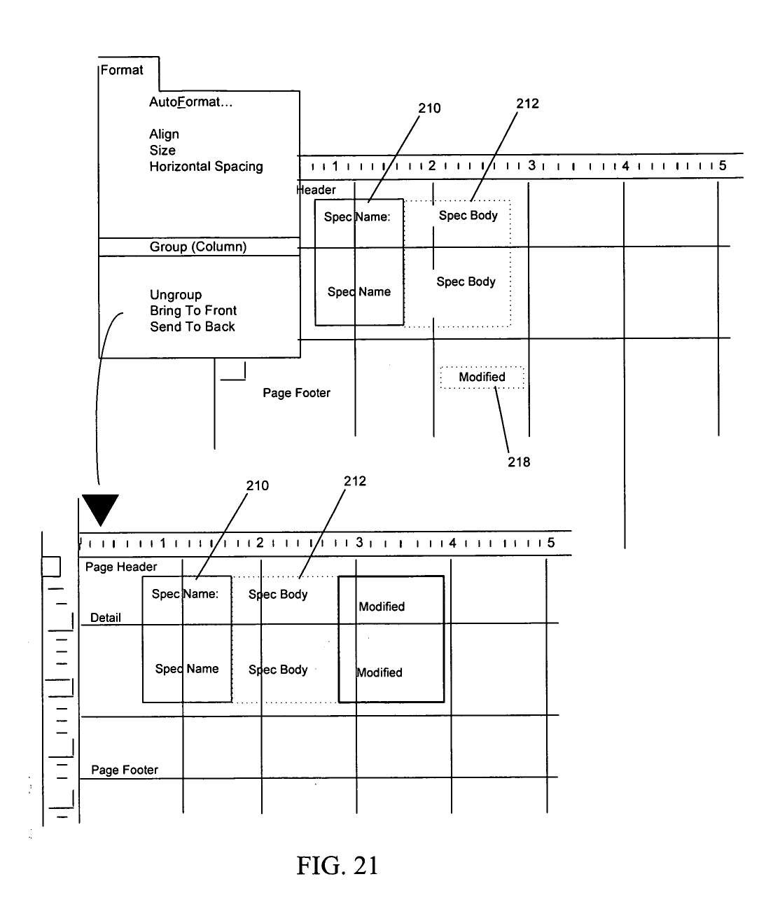

FIG. 21 is a diagram of a screen depicting a Modified object 218 being added to a view. The object that is to be added in FIG. 21, identified as a Modified object 218, does not have a label corresponding thereto. If the table has a table format that is tabular, each object that is subsequently added to the table becomes a column of the table. If the table has a table format that is stacked, each object that is subsequently added to the table becomes a row of the table.

The Modified object 218 has a top-left corner that is further to the right than any object belonging to the table. Accordingly, the new column is to be added to the right of any column belonging to the table. The new object (i.e., the Modified object 218) and each of the objects of the table are re-assigned ordinal values, and since the object to be added to the table has an anchor point further to the right than any anchor point of any object belonging to the table, the object to be added is assigned a higher ordinal value than any object belonging to the table. Accordingly, the object to be added is added to the right of the table.

Although not shown in FIG. 21, if desired, the designer may be notified where any new objects may be positioned. A graphical device, such as a vertical line intersected by a horizontal line or cross-hash can show a designer where a next-to-be-added object will be positioned. The vertical line is used instead of a horizontal line, since the table has a tabular table format; if the table has a stacked table format, a horizontal line is used to show the designer where the next-to-be-added object is to be positioned. In the example shown in FIG. 21, the object to be added has a label corresponding thereto. Since the table has a tabular table format, the label corresponding to the object is to be added above the object itself. If the table has a stacked table format, then the label corresponding to the object would be added to the left of the object itself unless the object has an RTL property set to “true,” in which case the label corresponding to the object would be added to the right of the object itself.

Since table format is tabular, adding an object to a layout grouping is equivalent to adding a new column to the table. The new column is to contain the object and its corresponding label. The vertical line is blue, and has a width of two pixels. For example, first cross-hash and a second cross-hash, each having a width of one pixel, show an upper boundary and a lower boundary of the new column, respectively. A central cross-hash shows where any text of the object will be positioned.

A label is created and added to the table in the header group. The label corresponds to the new object, i.e. the Modified object 218.

### Ungrouping a Control From a Table

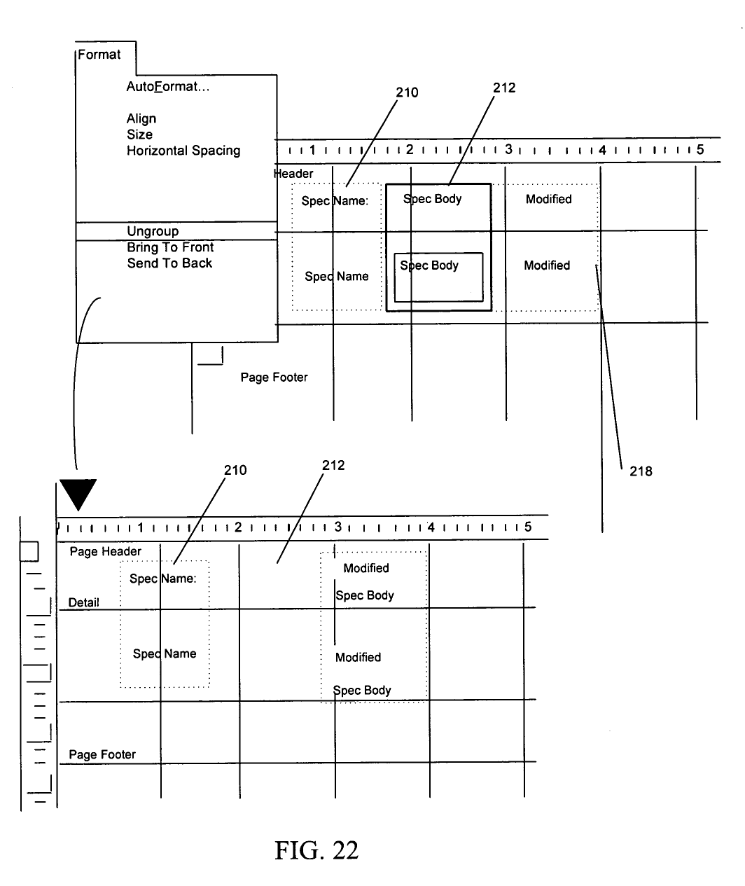

FIG. 22 is a screen of an ungrouping of a control (i.e., an object) from a table. The table has a tabular layout grouping, and therefore an ungrouping of an object removes a column from the table; if the table has a sacked layout grouping, then ungrouping an object removes a row from the table. The table contains three objects, each having a label corresponding thereto: a Spec Name object 210, a Spec Body object 212, and a Modified object 218. The Modified object 218 is selected, and therefore the Modified object 218 is to be ungrouped from the table.

The object and its label are simply cut from the table and pasted elsewhere in the view. The object and its label are pasted below the table, where the object and label may avoid overlapping any other object. Generally, the object and its label are pasted slightly to the right of the table (if the table either does not have an RTL property or has an RTL property that is set to “false”) so that, if the object (and its label) are subsequently grouped with the remaining objects of the table, the object may be added to the right of any other object of the table.

### Deleting Objects

Just as objects may be cut, so may objects be deleted. When a row is deleted from a table, any rows that may be below it may be adjusted upward to eliminate any gaps between rows. For example, in a stacked table, an object may be removed from the layout grouping. If a row contains only one object of the layout grouping, then removing the object from the layout grouping is equivalent to deleting the row. The object may be removed from the layout grouping by a Field Remover, which has a designer interface similar in appearance to a Field Chooser. The object may also be removed by selecting the row and deleting, or by cutting. The designer may be prompted to determine whether the designer wishes to collapse any gap between adjacent rows, or a default may be set to collapse the gap between adjacent rows.

When a column is deleted from a table, any columns that may be to the right may be adjusted leftward (or, if the column that is to be deleted has an RTL property that is “true,” any columns that may be to the right may be adjusted rightward) to eliminate any gaps between columns. For example, in a tabular table, an object may be removed from the layout grouping. If a column contains only one object of the layout grouping, then removing the object from the layout grouping is equivalent to deleting the column. The object may be removed from the layout grouping by a Field Remover, which has a designer interface similar in appearance to a Field Chooser. The object may also be removed by selecting the column and deleting, or by cutting. The designer may be prompted to determine whether the designer wishes to collapse any gap between adjacent columns, or a default may be set to collapse the gap between adjacent columns.

### Disassociating Objects

A designer may also command that a control group such as a row or a column be disassociated from a table. If a row is disassociated from a table, then it is cut from the table and pasted below the table. If a column is disassociated from a table, then it is cut from the table, and pasted to the right of the table (if the column that is deleted has no RTL property set to “true”) or to the left of the table (if the column that is deleted has an RTL property set to “true”). Any table from which a control group has been disassociated may be adjusted to eliminate any gap that is created by the cutting of the control group.

An object may be disassociated from a table in response to a remove-from-group command. In response to the remove-from-group command when a plurality of removable objects is selected within a table, the plurality of removable objects is disassociated from all control groups of the table, and is moved away from the table. Remaining control groups may be adjusted as necessary to minimize distances between adjacent rows and between adjacent columns.

If a row is selected when the designer commands that the control group be disassociated from the table, then the row may be cut from the table and pasted below the table. If a column is selected when the designer commands that the control group be disassociated from the table, then the column may be cut from the table and may be pasted to the right of the table (if the column that is deleted has no RTL property set to “true”) or to the left of the table (if the column that is deleted has an RTL property set to “true”). Any table from which a control group has been disassociated may be adjusted to eliminate any gap that may be created by the cutting of the control group.

A designer may multi-select control groups and command that multi-selected control groups be disassociated from their respective tables. For example, one or more rows in one or more tables may be selected when the designer commands that the selected control groups be disassociated from their respective tables. In such a situation, each selected row is cut from its respective table, pasted below the last table, and joined into a new table that contains all of the rows thus cut. Each row becomes a row of the new table. The designer may also command that all rows be concatenated into a single-row table.

Similarly, one or more columns in one or more tables may be selected when the designer commands that the selected control groups be disassociated from their respective tables. In such a situation, each selected column is cut from its respective table, pasted to the right of the last table (or left, if the table has an RTL property set to “true”), and joined into a new table that contains all of the columns thus cut. Each of the columns that has been cut becomes a column of the new table. The designer may also command that all columns be concatenated into a single-column table.

If at least one column and at least one row are selected when the designer commands that the selected control groups be disassociated from their respective tables, then each selected row and each selected column is cut from its respective table. A new table is created into which all of the objects of the cut rows and cut columns are pasted. The new table has a desired layout grouping that is stacked if the number of columns thus cut exceeds the number of rows thus cut, and is tabular otherwise. For example, if the designer selects two rows and one column, regardless of whether the rows and the column belong to different tables, and then the designer commands that the selected control groups be disassociated from their respective tables, a new table having a tabular layout grouping is created.

### Undoing

If desired, commands issued by the designer may be “undoable.” In other words, before a command from the designer is implemented, a temporary file may be created or appended to store sufficient information to restore the table to a status quo ante. A complete description of each deleted object, an a-priori position or an adjustment-vector of each object movement, and an identifier of any new object added to the table may be inserted into the temporary file. Alternatively, a complete copy of the table may be maintained in the temporary file so that the table may be replaced by the copy of the table in response to an “undo” command.

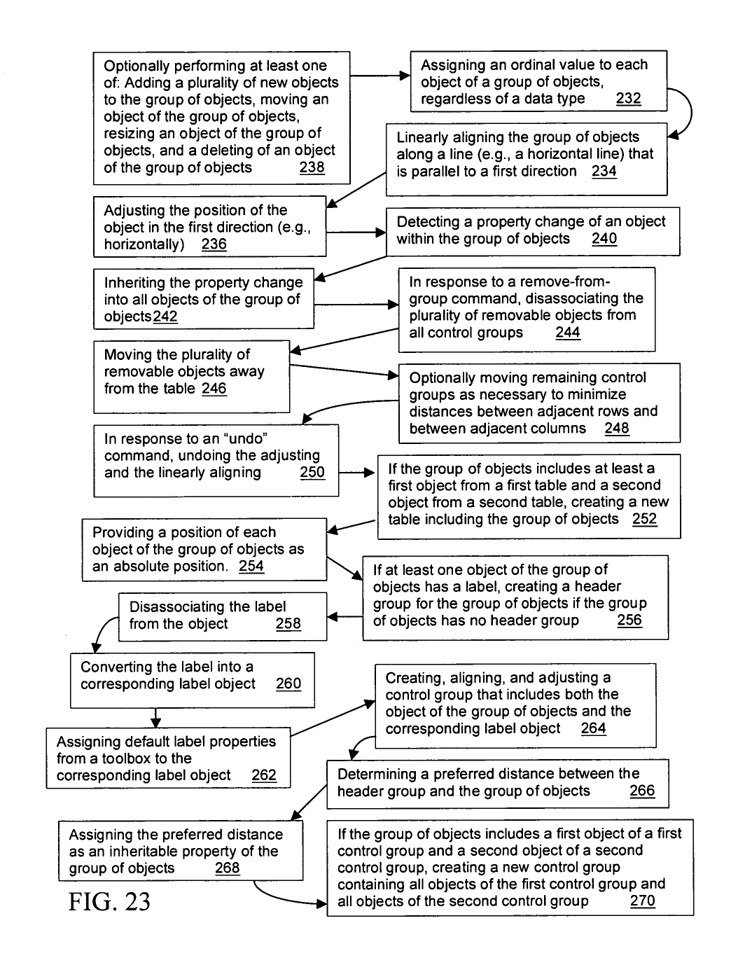

FIG. 23 is a flowchart depicting a method in accordance with one embodiment of the present invention. The method may be used to achieve an arrangement of objects within a view. For example, the view may include a group of objects, also referred to hereinafter as a layout grouping, that may be selected and that are not labels. Each object of the layout grouping may have a position within the view.

The method includes assigning an ordinal value to each object of the layout grouping regardless of a data type 232, in accordance with the position of the object in a first direction, relative to other objects of the layout grouping. For example, a lowest ordinal value may be assigned to a first object that is leftmost within the view, and a greatest ordinal value may be assigned to a second object that is rightmost within the view.

The layout grouping is linearly aligned along a line that is parallel to the first direction, regardless of data type 234. For example, if the desired table structure is tabular, then the objects may be aligned along a horizontal line, such that the linearly aligning of the layout grouping is along a horizontal line. The alignment may be by tops, bottoms, centerlines, or otherwise, as determined by a preference that that the user may modify. If the desired table structure is stacked, then the line may be vertical, such that the linearly aligning of the layout grouping is along a vertical line.

The position of each object in the layout grouping is then adjusted in the first direction (e.g., horizontally) such that the object does not overlap any other object of the layout grouping having a lower ordinal value 236. Specifically, the position of each object may be moved, by an increment of one pixel at a time, until the object no longer overlaps any other object of the layout grouping having a lower ordinal value. Of course, the increment by which the object may be moved is subject to modification by alteration of an increment preference within a preference table. Depending on the RTL value, if any, each object may be moved to the right or to the left, until the object does not overlap any other object of the layout grouping having a lower ordinal value.

If desired, the adjusting may be maximal, in that the adjusting may be used to compress the table of objects into a small region of the view. The object of the layout grouping having the lowest ordinal value may be moved as close to the left edge of the view as possible if the desired table structure is tabular (or as close to the right edge of the view as possible, if an RTL value is true), or as close to the top edge of the view as possible if the desired table structure is stacked. Each successive object of the layout grouping may be moved as much as possible in the same direction without overlapping any object of the layout grouping having a lower ordinal value. However, in the embodiment of FIG. 23, the adjusting is minimal, so that the object is moved as slightly as possible. Regardless of whether the adjusting is minimal, maximal, or otherwise, no object of the layout grouping is allowed to overlap any other object of the layout grouping having a lower ordinal value.

If the line is horizontal (i.e., if the desired table structure is tabular), then the first direction is horizontally rightward, such that for each object in the layout grouping that does not have a true RTL property, the position of the object is adjusted to the right. For each object in the layout grouping that does have a true RTL property, the position is adjusted to the left, such that the object does not overlap any other object of the layout grouping having a lower ordinal value. In a stacked table, on the other hand, the first direction is vertically downward, such that the position of the object is adjusted downward, and such that the object does not overlap any other object of the layout grouping having a lower ordinal value.

Optionally, before assigning the ordinal value to each object, the layout grouping may be altered. A plurality of new objects may be added to the view such that the layout grouping includes the plurality of new objects. Adding the plurality of new object may be performed before assigning the ordinal value to each object of the layout grouping. The layout grouping may be altered by adding at least one new object to the layout grouping, moving an object of the layout grouping, resizing an object of the layout grouping, or deleting an object of the layout grouping 238. Several objects of the layout grouping may be moved, resized, or deleted, or several new objects may be added to the layout grouping. Altering the layout grouping may require recalculation of the ordinal values; consequently, the alteration precedes the assigning of the ordinal values.

If the layout grouping has been altered such that any property of any object of the layout grouping may have been altered, then a property change of an object within the layout grouping is detected 240. The property change may have been applied to only one object, or to many objects. Since all of the objects in the layout grouping have been selected, it may be assumed that the user wishes to apply the property change to all of the objects in the layout grouping. Accordingly, the property change is inherited into all objects of the layout grouping 242. Accordingly, if at least one object of the layout grouping has an inheritable property that does not conflict with any inheritable property of any other object of the layout grouping, the inheritable property may be inherited into any object of the layout grouping that does not have a conflicting property.

The layout grouping may be altered by, for example, resizing. If a vertical control group (that is, a column) is resized, e.g. by horizontally dragging a resizer that is at a right edge of a control group, then a column width of the control group is adjusted in accordance with the horizontal dragging, such that the column width remains greater than zero. Each column that may be to the right of the resizer is moved. If a horizontal control group (that is, a row) is resized, e.g. by vertically dragging a resizer that is at a bottom edge of a control group, then a row height of the control group is adjusted in accordance with the vertical dragging, such that the row height remains greater than zero. Each row that may be below the resizer is moved accordingly.

The layout grouping may also be altered by, for example, a remove-from-group command when a plurality of removable objects is selected within a table. In response to a remove-from-group command, the plurality of removable objects may be disassociated from all control groups 244. The plurality of removable objects may be moved away from the table 246. Any remaining control groups may be moved as necessary to minimize distances between adjacent rows and between adjacent columns, or gaps may be left between adjacent rows and between adjacent columns.

If desired, the control groups may be moved to minimize distances 248. In other words, each column may be moved as close as possible to a previous column without overlapping. In a tabular table having an RTL property that is true, each column (other than the rightmost) having a gap to its right may be moved to the right until there is no distance between it and the immediately adjacent column to its right, without overlapping. In all other tabular tables, each column (other than the leftmost) having a gap to its left may be moved to the left until there is no distance between it and the immediately adjacent column to its left, without overlapping. In stacked tables, each row (other than the topmost) having a gap above it may be moved upward until there is no distance between it and the immediately adjacent row above it, without overlapping.

If desired, an “undo” functionality may be included. In response to an “undo” command, the adjusting and the linearly aligning may be “undone” 250.

If the layout grouping includes at least a first object from a first table and a second object from a second table when a remove-from-table command is received, the objects that are selected are cut and then pasted into a new table that includes the layout grouping 252.

If desired, a position of each object of the layout grouping may be provided as an absolute position 254. Providing the position of each object as an absolute position may facilitate backward compatibility with previous versions of well-known software. The position of each object may also be provided as a relative position. Whether the position is provided as an absolute or relative position may be determined by a preference within the preferences table.

If at least one object of the layout grouping has a label, then a header group may be created for the layout grouping if the layout grouping has no header group 256. For example, a text box into which the designer intends for a user to type a phone number may have a label that reads “Phone Number.” The header group is parallel to the line to which the objects of the layout grouping are aligned; that is, if the desired table structure is tabular, then the header group is horizontal, and if the desired table structure is stacked, then the header group is vertical.

Once a determination is made that a header group exists, a label object may be created for each object of the layout grouping that has a label but does not have a corresponding label object. Creating the label object includes disassociating the label from the object 258. The label may therefore become a distinct object, with an existence independent of the object to which it pertains. Once the label has been disassociated, then the label may be converted into a corresponding label object 260. Default label properties may be assigned from a toolbox to the corresponding label object 262.

The label objects themselves may form a control group. For example, if the desired table structure is tabular, then the label objects may form a row, and if the desired table structure is stacked, then the label objects may form a column. The control group that contains the label objects is thus created, and may be aligned and adjusted.

Also, each label object forms a control group with the object to which it pertains. For example, if the desired table structure is tabular, then each label object and the object to which it pertains may form a column, and if the desired table structure is stacked, then each label object and the object to which it pertains may form a row. Each control group that contains a label object and an object to which it pertains may thus be created, and may be aligned and adjusted 264.

The header group may be moved to a preferred distance from the layout grouping. The preferred distance may be obtained from the preferences table. If a preferred distance is present within the preferences table, then instead of adjusting each header object so that it is as close as possible to the object to which it pertains, each header object may be moved to a preferred distance from the object to which it pertains 266. The preferred distance is the distance between the header group and the layout grouping. For example, if the desired table structure is tabular, the header group may be implemented a preferred distance of one centimeter above the layout grouping. If the desired table structure is tabular, the header group may be implemented a preferred distance of one centimeter to the left of the layout grouping, or to the right of the layout grouping if an RTL property is true.

If a preferred distance is present within the preferences table, then all other objects within the layout grouping may inherit the preferred distance 268. In other words, all of the header objects that pertain to the layout grouping may be adjusted and/or moved such that each is the preferred distance from the object to which it pertains. If the group of object is linearly aligned as a first row, then the header group may be linearly aligned as a second row parallel to the first row. If the layout grouping is linearly aligned as a first column, then the header group may be linearly aligned as a second column.

It may be that objects of different tables are selected. For example, the designer may select one or more objects from a first table, and one or more objects from a second table. If the designer selects more than one layout grouping including a first object from a first table and a second object from a second table, then the first object and the second object are removed from their respective tables and a new table is created that includes the first object and the second object.

Similarly, it may be that objects of different rows and columns are selected within a common table. If the layout grouping includes a first object from a first column and a second object from a second column of the same table as the first column, then a new column may be created containing all objects of the first control group and all objects of the second control group 270. The new column may be to the right of all other columns of the table, or to the left of all other columns of the table if an RTL property is true. If the layout grouping includes a first object from a first row and a second object from a second row of the same table as the first row, then a new row may be created containing all objects of the first control group and all objects of the second control group.

### Media and Systems

In accordance with the second embodiment of the present invention, a method for performing any of the aforementioned techniques may be encoded as a set of computer-readable instructions on a computer-readable medium. When executed by a computer system, the computer-readable instructions cause the computer system to arrange objects within a view, where the view includes a layout grouping that are selected and that are not labels. Each object of the layout grouping has a position within the view.

In accordance with the third embodiment of the present invention, a method for performing any of the aforementioned techniques may be encoded as a set of computer-readable instructions on a storage device, such as a memory or computer-readable medium, coupled to or residing in a computer system. The computer system comprises a processor, a bus coupled to the processor, and a memory coupled to the bus. The memory contains computer-readable instructions. When executed by the processor (or any device coupled to or residing in the computer system), the computer-readable instructions cause the computer system to arrange objects within a view, where the view includes a layout grouping that are selected and that are not labels.

In the system thus described, therefore, each object is aware of a subset of other objects in the form or report. Each object is assigned an ordinal value which is used to determine the control's role in placement with regard to other objects around it. Also, upon modification of that object's position or size, the capability exists to update the sizes and positions of other objects in the group without changing unrelated bits of the system (objects it has not been grouped with).

### Adaptive to Hardware

In accordance with a fourth embodiment of the present invention, a computer system includes a processor, a monitor, and a module operatively coupled to the processor and to the monitor. The monitor may have a pixel resolution, a height, and a width that are unadjustable. The module may be or may include, for example, a set of instructions residing on computer-readable medium within the computer system. The computer system may be configured such that the set of instructions may be executed by the processor. However, if desired, the module may be implemented entirely in hardware, and may be coupled to the processor and to a graphics controller within the computer system. The module may also be implemented as a firmware function, such as a BIOS (Basic Input/Output System) or Operating System routine, operative to detect and respond to an overflow status within a view on the monitor.

The module may be operative to determine a height and width of a computer monitor. If the module is implemented as a set of instructions, then the set of instructions may be operative to cause the processor to read a monitor size from memory, where the memory size has been written by a firmware function. If the module is implemented in firmware, then the module may access the monitor size directly, or may attempt to write to and then read from a video RAM (random access memory). The monitor size includes the pixel resolution, the height, and the width of the monitor.

If the monitor size is written into memory by firmware, such as by a system BIOS function or a graphics controller function, then the module may be further operative to read the monitor size from memory. The monitor size may be regarded as firmware-writable data within the memory of the computer system, and includes the pixel resolution, the height, and the width that are unadjustable.

Once the module has determined the monitor size, the module may further be operative to determine a height and width of each object within a table of objects, as represented on the computer monitor. For example, if a Microsoft Access or other application is executing on the processor, the module coupled to the process may determine that a table of objects is presented on the monitor. The module may also determine a height and width of each object within the table of objects, including any gaps that may be presented between objects of the table of objects and including any labels and/or label objects that may also be presented on the monitor.

Based upon the height and width of the computer monitor and the height and width of each object within the table of objects, the module may select a group of removable objects (and any labels and/or label objects that may pertain to the group of removable objects) from the table of objects. For example, if the application (which may be Microsoft Access) has a window that is larger (in any dimension) than the monitor size, then the module may select at least one column of objects and/or at least one row of objects that, if removed from the table of objects, would enable the table of objects to fit within the monitor size.

Accordingly, the module is operative to cut the group of removable objects, and any labels and/or label objects that may pertain thereto, from the table of objects, such that the table of objects other than the removable objects is able to fit within the monitor. The module is also operative to adjust the objects (other than the removable objects) to fit within the monitor.

The module is further operative to create a new table below the table; and to paste the group of removable objects, and any labels and/or label objects that may pertain thereto, into the new table. The fourth embodiment of the present invention therefore includes both hardware and software aspects, since the set of instructions may interact with physical parameters of the computer system (i.e., the height and width of the monitor).

In other words, the monitor may have an unadjustable monitor size including a height and a width, and the processor may be operative to execute software for presenting a table of objects on the monitor. The module may be operative to coerce the table of objects to fit within the unadjustable monitor size. The module selects and cuts a group of removable objects, and any labels and/or label objects that may pertain thereto, from the table of objects, such that the table of objects other than the removable objects is able to fit within the unadjustable monitor size. The module then adjusts the objects (other than the removable objects) to fit within the unadjustable monitor size. The removable objects (and any labels and label objects that may pertain thereto) are not lost; they are pasted into a new table below the table. The removable objects of the new table may also be adjusted within the new table.

Although the subject matter has been described in language specific to structural features and/or methodological acts, it to be understood that the subject matter defined in the appended claims is not necessarily limited to the specific features or acts described above. Rather, the specific features and acts described above are disclosed as example forms of implementing the claims.

### Conclusion

The foregoing description is therefore presented merely to include several examples of the invention. The invention is not limited by such description. The description should also be construed as including any novel feature or any novel combination of features disclosed either explicitly or implicitly or any generalization or modification thereof which would be apparent to persons skilled in the relevant art, and any and all legal equivalents thereof, whether or not such relates to the same invention as presently claimed in any claim and whether or not it mitigates any or all of the same technical problems as confronted by the present invention.

In other words, although the invention has been described with reference to several exemplary embodiments, the words that have been used are words of description and illustration, rather than words of limitation. Changes may be made within the purview of the appended claims without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A method for automatically arranging objects within a view, the view including a layout grouping that may be selected, each object of the layout grouping having a position within the view, the method including:
assigning an ordinal value to each object of the layout grouping regardless of a data type, in accordance with the position of the object in a first direction, relative to other objects of the layout grouping;
automatically aligning the layout grouping along a line that is parallel to the first direction, regardless of data type; and
for each object in the layout grouping, automatically adjusting the position of the object in the first direction such that the object has a minimum distance from each object having a lower ordinal value without overlapping any other object of the layout grouping.

2. The method for achieving an arrangement of objects within a view of claim 1, wherein:
the line is horizontal, such that the linearly aligning of the layout grouping is along a horizontal line; and
the first direction is horizontally rightward, such that for each object in the layout grouping that does not have a true RTL property, the position of the object is minimally adjusted to the right, and for each object in the layout grouping that does have a true RTL property, the position is minimally adjusted to the left, such that the object does not overlap any other object of the layout grouping having a lower ordinal value.

3. The method for achieving an arrangement of objects within a view of claim 1, wherein:
the line is vertical, such that the linearly aligning of the layout grouping is along a vertical line; and
the first direction is vertically downward, such that the position of the object is minimally adjusted downward, and such that the object does not overlap any other object of the layout grouping having a lower ordinal value.

4. The method for achieving an arrangement of objects within a view of claim 1, further comprising:
before assigning the ordinal value to each object of the layout grouping, adding a plurality of new objects to the layout grouping and to the view such that the layout grouping includes the plurality of new objects.

5. The method for achieving an arrangement of objects within a view of claim 4, further comprising:
if at least one object of the layout grouping has an inheritable property that does not conflict with any inheritable property of any other object of the layout grouping, inheriting the inheritable property that does not conflict with any inheritable property of any other object into the plurality of new objects.

6. The method for achieving an arrangement of objects within a view of claim 5, wherein:
the resizing includes:
if the layout grouping is a vertical control group:
horizontally dragging a resizer that is at a right edge of a control group, adjusting a column width of the-control group in accordance with the horizontal dragging, such that the column width remains greater than zero;
moving each column that may be to the right of the resizer; and
if the layout grouping is a horizontal control group:
vertically dragging a resizer that is at a bottom edge of a control group;
adjusting a row height of the control group in accordance with the vertically dragging, such that the row height remains greater than zero; and
moving each row that may be below the resizer.

7. The method for achieving an arrangement of objects within a view of claim 5, wherein inheriting the inheritable property further comprises:
detecting a property change of an object within the layout grouping; and
inheriting the property change into all objects of the layout grouping.

8. The method for achieving an arrangement of objects within a view of claim 1, further comprising:
in response to a remove-from-group command when a plurality of removable objects is selected within a table:
disassociating the plurality of removable objects from all control groups;
moving the plurality of removable objects away from the table; and
moving remaining control groups as necessary to minimize distances between adjacent rows and between adjacent columns.

9. The method for achieving an arrangement of objects within a view of claim 1, further comprising:
in response to an “undo” command, undoing the minimally adjusting and the linearly aligning.

10. The method for achieving an arrangement of objects within a view of claim 1, further comprising:
if the layout grouping includes at least a first object from a first table and a second object from a second table, creating a new table including the layout grouping.

11. The method for achieving an arrangement of objects within a view of claim 1, further comprising:
providing a position of each object of the layout grouping as an absolute position.

12. The method for achieving an arrangement of objects within a view of claim 1, further comprising:
if at least one object of the layout grouping has a label, creating a header group for the layout grouping if the layout grouping has no header group, such that the header group is parallel to the line to which the objects of the layout grouping are aligned;
for each object of the layout grouping that does not have a corresponding label object:
a) if the object has a label but not a corresponding label object,
disassociating the label from the object;
converting the label into a corresponding label object; and
assigning default label properties from a toolbox to the corresponding label object; and
b) creating, aligning, and minimally adjusting a control group that includes both the object of the layout grouping and the corresponding label object.

13. The method for achieving an arrangement of objects within a view of claim 12, wherein creating a header group further comprises:
determining a preferred distance between the header group and the layout grouping;
assigning the preferred distance as an inheritable property of the layout grouping; wherein one of:
(a) the layout grouping is linearly aligned as a first row, and the header group is linearly aligned as a second row parallel to the first row, and
(b) the layout grouping is linearly aligned as a first column, and the header group is linearly aligned as a second column.

14. The method for achieving an arrangement of objects within a view of claim 1, further comprising:
if the layout grouping includes a first object of a first control group and a second object of a second control group, creating a new control group containing all objects of the first control group and all objects of the second control group.

15. A computer-readable medium containing computer-readable instructions that when executed by a computer system cause the computer system to perform a method for achieving an arrangement of objects within a view, the view including a layout grouping that are selected and that are not labels, each object of the layout grouping having a position within the view, the method including:
assigning an ordinal value to each object of the layout grouping regardless of a data type, in accordance with the position of the object in a first direction, relative to other objects of the layout grouping;
for each object in the layout grouping, regardless of the data type of the object, minimally adjusting the position of the object such that the object does not overlap any other object of the layout grouping having a lower ordinal value; and
linearly aligning the layout grouping along a line in the first direction, such that the objects of the layout grouping are linearly aligned and non-overlapping with a minimum distance there-between.

16. The computer-readable medium of claim 15, wherein:
the first direction is horizontally rightward, such that for each object in the layout grouping that does not have a true RTL property, the position of the object is minimally adjusted to the right, and for each object in the layout grouping that does have a true RTL property, the position is minimally adjusted to the left, such that the object does not overlap any other object of the layout grouping having a lower ordinal value; and
the linearly aligning of the layout grouping is along a horizontal line.

17. The computer-readable medium of claim 15, wherein:
the first direction is vertically downward, such that the position of the object is minimally adjusted downward, such that the object does not overlap any other object of the layout grouping having a lower ordinal value; and
the linearly aligning of the layout grouping is along a vertical line.

18. A computer system comprising:
a processor;
a bus coupled to the processor; and
a memory containing computer-readable instructions that when executed by the processor cause the processor to perform a method for achieving an arrangement of objects within a view, the view including a layout grouping that are selected and that are not labels, each object of the layout grouping having a position within the view, the method including:
assigning an ordinal value to each object of the layout grouping regardless of a data type, in accordance with the position of the object in a first direction, relative to other objects of the layout grouping;
for each object in the layout grouping, regardless of the data type of the object, minimally adjusting the position of the object such that the object does not overlap any other object of the layout grouping having a lower ordinal value; and
linearly aligning the layout grouping along a line in the first direction, such that the objects of the layout grouping are linearly aligned and non-overlapping with a minimum distance there-between.

19. The computer system of claim 18, wherein:
the first direction is horizontally rightward, such that for each object in the layout grouping that does not have a true RTL property, the position of the object is minimally adjusted to the right, and for each object in the layout grouping that does have a true RTL property, the position is minimally adjusted to the left, such that the object does not overlap any other object of the layout grouping having a lower ordinal value; and
the linearly aligning of the layout grouping is along a horizontal line.

20. The computer system of claim 18, wherein:
the first direction is vertically downward, such that the position of the object is minimally adjusted downward, such that the object does not overlap any other object of the layout grouping having a lower ordinal value; and
the linearly aligning of the layout grouping is along a vertical line.
